(19) United States
(12) Patent Application Publication
(10) Pub. No.: US 2025/0175227 A1
(43) Pub. Date: May 29, 2025

(54) CROSS-FREQUENCY CHANNEL STATE INFORMATION

(71) Applicant: QUALCOMM Incorporated, San Diego, CA (US)

(72) Inventors: Qiaoyu LI, Beijing (CN); Yan ZHOU, San Diego, CA (US); Junyi LI, Greentown, PA (US); Mahmoud TAHERZADEH BOROUJENI, San Diego, CA (US); Tao LUO, San Diego, CA (US)

(21) Appl. No.: 18/836,314

(22) PCT Filed: Apr. 4, 2023
(86) PCT No.: PCT/CN2023/086122

§ 371 Date: Aug. 6, 2024

(30) Foreign Application Priority Data
Apr. 7, 2022 (WO) PCT/CN2022/085495

(51) Int. Cl. H04B 7/06; H04W 24/10

(52) U.S. Cl. CPC H04B 7/0626; H04W 24/10

(57) ABSTRACT

Certain aspects of the present disclosure provide techniques for cross-frequency channel state information. An example method of wireless communication by a user equipment includes receiving one or more settings indicating a first group of one or more resources associated with one or more first serving cells in a first cell group, the one or more settings further indicating a second group of one or more resources associated with a second serving cell in a second cell group; and reporting channel state information (CSI) associated with the second group of one or more resources based at least in part on one or more measurements associated with the first group of one or more resources.

### CROSS-REFERENCE TO RELATED APPLICATION(S)

This application claims benefit of and priority to PCT/CN2022/085495, filed Apr. 7, 2022, which is herein incorporated by reference in its entirety for all applicable purposes.

### INTRODUCTION

Aspects of the present disclosure relate to wireless communications, and more particularly, to techniques for determining channel state information and/or detecting a beam failure.

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects of the subject matter described in this disclosure can be implemented in a method of wireless communication by a user equipment. The method generally includes receiving one or more settings indicating a first group of one or more resources associated with one or more first serving cells in a first cell group, the one or more settings further indicating a second group of one or more resources associated with a second serving cell in a second cell group; and reporting channel state information (CSI) associated with the second group of one or more resources based at least in part on one or more measurements associated with the first group of one or more resources. In certain aspects, the second group of one or more resources includes one or more virtual resources, and the method further includes refraining from receiving one or more signals via the one or more virtual resources.

Certain aspects of the subject matter described in this disclosure can be implemented in s a method of wireless communication by a network entity. The method generally includes outputting one or more settings indicating a first group of one or more resources associated with one or more first serving cells in a first cell group, the one or more settings further indicating a second group of one or more resources associated with a second serving cell in a second cell group; and obtaining first CSI associated with the second group of one or more resources based at least in part on the first group of one or more resources. In certain aspects, the second group of one or more resources includes one or more virtual resources, and the method further includes refraining from transmitting one or more signals via the one or more virtual resources.

Certain aspects of the subject matter described in this disclosure can be implemented in an apparatus for wireless communication. The apparatus generally includes a memory and a processor coupled to the memory. The processor is configured to: receive one or more settings indicating a first group of one or more resources associated with one or more first serving cells in a first cell group, the one or more settings further indicating a second group of one or more resources associated with a second serving cell in a second cell group; and report channel state information (CSI) associated with the second group of one or more resources based at least in part on one or more measurements associated with the first group of one or more resources. In certain aspects, the second group of one or more resources includes one or more virtual resources, and the processor is further configured to refrain from receiving one or more signals via the one or more virtual resources.

Certain aspects of the subject matter described in this disclosure can be implemented in an apparatus for wireless communication. The apparatus generally includes a memory and a processor coupled to the memory. The processor is configured to: output one or more settings indicating a first group of one or more resources associated with one or more first serving cells in a first cell group, the one or more settings further indicating a second group of one or more resources associated with a second serving cell in a second cell group; and obtain first channel state information (CSI) associated with the second group of one or more resources based at least in part on the first group of one or more resources. In certain aspects, the second group of one or more resources includes one or more virtual resources, and the processor is further configured to refrain from transmitting one or more signals via the one or more virtual resources.

Certain aspects of the subject matter described in this disclosure can be implemented in an apparatus for wireless communication. The apparatus generally includes means for receiving one or more settings indicating a first group of one or more resources associated with one or more first serving cells in a first cell group, the one or more settings further indicating a second group of one or more resources associated with a second serving cell in a second cell group; and means for reporting channel state information (CSI) associated with the second group of one or more resources based at least in part on one or more measurements associated with the first group of one or more resources. In certain aspects, the second group of one or more resources includes one or more virtual resources, and the apparatus further includes means for refraining from receiving one or more signals via the one or more virtual resources.

Certain aspects of the subject matter described in this disclosure can be implemented in an apparatus for wireless communication. The apparatus generally includes means for outputting one or more settings indicating a first group of one or more resources associated with one or more first serving cells in a first cell group, the one or more settings further indicating a second group of one or more resources associated with a second serving cell in a second cell group; and means for obtaining first channel state information (CSI) associated with the second group of one or more resources based at least in part on the first group of one or more resources. In certain aspects, the second group of one or more resources includes one or more virtual resources, and the apparatus further includes means for refraining from transmitting one or more signals via the one or more virtual resources.

Certain aspects of the subject matter described in this disclosure can be implemented in a computer-readable medium. The computer-readable medium has instructions stored thereon, that when executed by an apparatus, cause the apparatus to perform operations including receiving one or more settings indicating a first group of one or more resources associated with one or more first serving cells in a first cell group, the one or more settings further indicating a second group of one or more resources associated with a second serving cell in a second cell group; and reporting channel state information (CSI) associated with the second group of one or more resources based at least in part on one or more measurements associated with the first group of one or more resources. In certain aspects, the second group of one or more resources includes one or more virtual resources, and the instructions further cause the apparatus to refrain from receiving one or more signals via the one or more virtual resources.

Certain aspects of the subject matter described in this disclosure can be implemented in a computer-readable medium. The computer-readable medium has instructions stored thereon, that when executed by an apparatus, cause the apparatus to perform operations including outputting one or more settings indicating a first group of one or more resources associated with one or more first serving cells in a first cell group, the one or more settings further indicating a second group of one or more resources associated with a second serving cell in a second cell group; and obtaining first channel state information (CSI) associated with the second group of one or more resources based at least in part on the first group of one or more resources. In certain aspects, the second group of one or more resources includes one or more virtual resources, and the instructions further cause the apparatus to refrain from transmitting one or more signals via the one or more virtual resources.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example wireless communication network with cross-frequency channel state information (CSI) and/or beam failure detection (BFD).

FIG. 6 depicts another example wireless communication network with cross-frequency CSI/BFD.

FIG. 7 depicts another example wireless communication network where machine learning processes the cross-frequency CSI/BFD.

FIG. 8 depicts an example CSI report setting indicating cross-frequency resources.

FIG. 9 depicts an example CSI report setting indicating cross-frequency resources via separate CSI resource sets for each of the serving cells.

FIG. 10 depicts an example wireless communication network where a serving cell has multiple transmission-reception points.

FIG. 11 illustrates an example networked environment in which a predictive model is used for cross-frequency CSI/BFD.

FIG. 12A depicts an example signaling flow for communications in a network between a user equipment and multiple serving cell groups.

FIG. 12B depicts an example signaling flow for communications in a network between a user equipment and multiple serving cell groups.

FIG. 13 depicts a method for wireless communications, for example, by a user equipment.

FIG. 14 depicts a method for wireless communications, for example, by a network entity.

FIG. 15 depicts aspects of an example communications device, for example, a user equipment.

FIG. 16 depicts aspects of an example communications device, for example, a base station.

### DETAILED DESCRIPTION

Aspects of the present disclosure provide apparatuses, methods, processing systems, and computer-readable mediums for determining cross-frequency channel state information and/or detecting a cross-frequency beam failure.

Wireless communication networks (e.g., 5G New Radio (NR) systems or other wireless systems) may use channel state information (CSI) feedback (e.g., indications of channel quality) from a user equipment (UE) for adaptive communications. A network entity (e.g., a base station) may adjust certain communication parameters at a UE in response to CSI feedback from the UE. For example, link adaptation (such as adaptive modulation and coding with various modulation schemes and channel coding rates and/or transmit power control) at the UE may be applied to certain communication channels in response to CSI feedback from the UE. For channel state estimation purposes, the UE may be configured to measure a reference signal (e.g., a CSI reference signal (CSI-RS)) and estimate the downlink channel state based on the CSI-RS measurements. The UE may report an estimated channel state to the network entity in the form of CSI, which may be used in link adaptation. The CSI may indicate channel properties of a communication link between a network entity and a UE. The CSI may represent the effect of, for example, scattering, fading, and pathloss of a signal across the communication link.

Certain wireless communication systems (e.g., 5G NR) may support a beam failure recovery procedure. Beam failure may be detected at a UE by monitoring a reference signal (e.g., CSI-RS). The UE may send, to the network, a beam failure recovery request, and the network entity may output (for example, to the UE) an indication to communicate via a different beam in response to the beam failure recovery request.

In certain cases, the UE may support communications via multiple frequency ranges, such as a first frequency range (e.g., including sub-6 GHz bands) and second frequency range (e.g., including millimeter wave (mmWave) bands). In one or more examples, beams from the network entity in the second frequency range may have a narrower beam shape compared to beams in the first frequency range. For example, a beam in the first frequency range may have a larger coverage area compared to a beam in the second frequency range. In the second frequency range, the network entity may transmit beams using time-division multiplexing (TDM), whereas in the first frequency range, the network entity may transmit beams using code-division multiplexing (CDM) and/or frequency-division multiplexing (FDM). For example, a single beam in the second frequency range may be transmitted per transmission time interval due to TDM, whereas multiple beams in the first frequency range may be transmitted in a transmission time interval due to CDM and/or FDM. The UE may consume more power to receive beams in the second frequency range than power consumed to receive beams in the first frequency range, for example, due to the UE adjusting the receive beams in the second frequency range via analog phase shifting instead of digital or hybrid beamforming. For example, the UE may apply analog beamforming to receive beams in the second frequency range, whereas the UE may apply hybrid or digital beamforming in the first frequency range.

Certain aspects of the present disclosure provide methods and apparatus for cross-frequency CSI and/or beam failure detection (BFD). For example, a UE may monitor a first set of reference signals in a first frequency range and report CSI for a second set of reference signals in a second frequency range based on measurements of the first set of reference signals. In some cases, the UE may detect a beam failure associated with the second set of reference signals based on measurements of the first set of reference signals, and the UE may transmit a beam failure recovery request in response to the beam failure. In certain cases, the first set of reference signals may be in frequency range 1 (FR1), and the second set of reference signals may be in frequency range 2 (FR2), as further described herein. In certain aspects, machine learning may be used to determine the CSI/BFD for cross-frequency resources, as further described herein. In some cases, machine learning may allow the UE to determine cross-frequency CSI/BFD.

The cross-frequency CSI/BFD described herein may enable reduced overhead, for example, due to wider FR1 beams serving more UEs compared to the narrower FR2 beams. As the FR1 beams may have wider beams compared to the FR2 beams, the FR1 beams may serve more UEs with a wider coverage area and allow for more UEs to determine FR2 beam characteristics based on the FR1 beams.

The cross-frequency CSI/BFD described herein may enable flexible scheduling of the CSI/BFD, for example, due to the FR1 beams being transmitted via FDM and/or CDM. For example, as multiple FR1 beams may be transmitted in the same time-domain resources with FDM and/or CDM, the UE may monitor multiple FR1 beams in the same time-domain resources compared to the TDM FR2 beams, which may use a single time-domain resource per FR2 beam for TDM.

The cross-frequency CSI/BFD described herein may enable efficient power consumption at the UE, for example, due to receiving FR1 beams consuming less power than receiving FR2 beams. As the UE may monitor FR1 beams and determine CSI/BFD for FR2 beams based on measurements of the FR1 beams, the UE may consume less power monitoring the FR1 beams.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

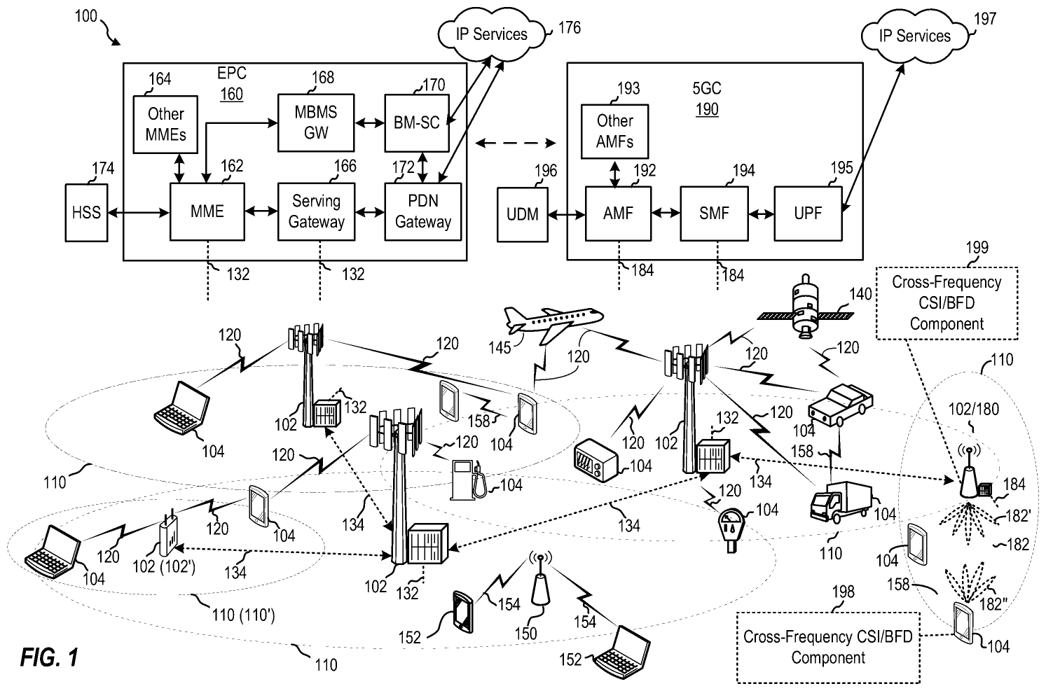

FIG. 1 depicts an example of a wireless communications network 100, in which aspects described herein may be implemented. Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a network entity, a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

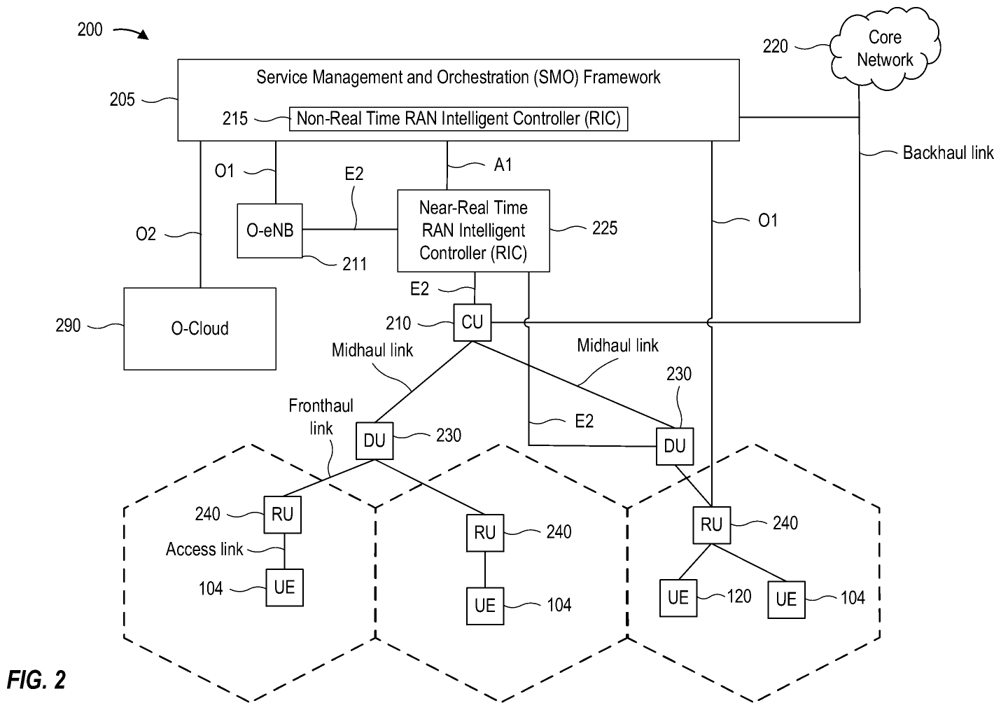

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

In 5G NR two initial operating bands have been identified as frequency range designations FR1 (410 MHZ-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHz), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Communications using mm Wave/near mm Wave radio frequency band (e.g., 3 GHz-300 GHz) may have higher path loss and a shorter range compared to lower frequency communications. As described above with respect to FIG. 1, a base station (e.g., BS 180) configured to communicate using mm Wave/near mm Wave radio frequency bands may utilize beamforming (e.g., beamforming 182) with a UE (e.g., UE 104) to improve path loss and range.

Further, as described herein, a UE may determine CSI/BFD associated with mmWave bands based on measurements of resources in sub-6 GHz bands.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. BS 180 may also receive the beamformed signal from UE 104 in one or more receive directions 182′. Base station 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

Wireless communication network 100 includes a cross-frequency CSI/BFD component 199, which may be configured to output an indication of resources for determining cross-frequency CSI/BFD at a UE and obtain the CSI and/or a beam failure recovery request from the UE. Wireless communication network 100 further includes a cross-frequency CSI/BFD component 198, which may be configured to receive an indication of resources for determining cross-frequency CSI/BFD and transmit CSI and/or a beam failure recovery request to a network entity.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

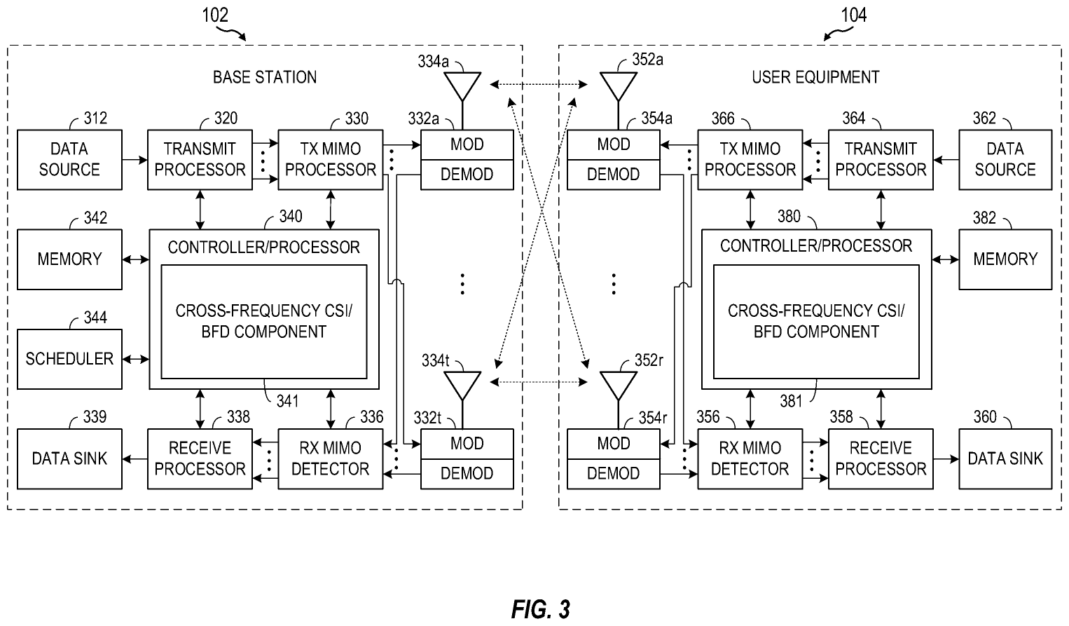

FIG. 3 depicts aspects of an example BS 102 and a UE 104. Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting (sending or providing) data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

BS 102 includes controller/processor 340, which may be configured to implement various functions related to wireless communications. In the depicted example, controller/processor 340 includes a cross-frequency CSI/BFD component 341, which may be representative of the cross-frequency CSI/BFD component 199 of FIG. 1. Notably, while depicted as an aspect of controller/processor 340, the cross-frequency CSI/BFD component 341 may be implemented additionally or alternatively in various other aspects of BS 102 in other implementations. In certain aspects, the cross-frequency CSI/BFD component 341 may be implemented via a CU, a DU, and/or a RU, for example as described herein with respect to FIG. 2.

UE 104 includes controller/processor 380, which may be configured to implement various functions related to wireless communications. In the depicted example, controller/processor 380 includes a cross-frequency CSI/BFD component 381, which may be representative of the cross-frequency CSI/BFD component 198 of FIG. 1. Notably, while depicted as an aspect of controller/processor 380, the cross-frequency CSI/BFD component 381 may be implemented additionally or alternatively in various other aspects of UE 104 in other implementations.

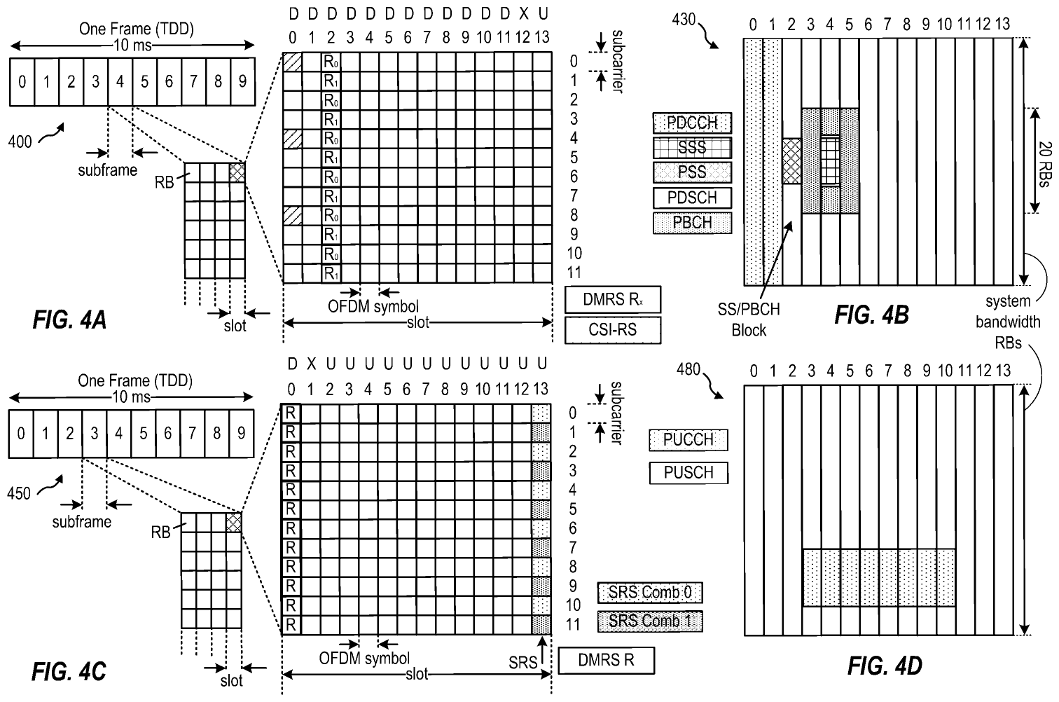

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μslots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB). An SSB can also be referred to as a synchronization signal block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

Certain wireless communication systems (e.g., 5G NR) may support a beam failure recovery procedure. Beam failure may be detected at a UE by monitoring a reference signal (e.g., CSI-RS and/or SSB) and assessing if a beam failure trigger condition has been met. For example, beam failure detection (BFD) may be triggered if an estimated block error rate (BLER) of the reference signal(s) is greater than or equal to a threshold (e.g., 10%). In some cases, beam failure detection may be assessed at layer-1 and reported to layer-2 as a beam failure indication. In some cases, if a measured signal quality (e.g., a reference signal receive power (RSRP)) of the reference signals meet certain criterion (e.g., below a certain threshold for a certain time period), the beam failure recovery (BFR) procedure may be initiated. Layer-2 may trigger transmission of a beam failure recovery request (BFRQ) in response to receiving a certain number of beam failure indications within a certain duration from Layer-1. When the UE has declared beam failure and found a new beam, the UE may transmit a BFRQ (e.g., a RACH preamble) to the serving base station. The base station may respond to the request by transmitting a beam failure recovery response (BFRR) to the UE. If the response is received successfully at the UE, the beam recovery is completed and a new beam pair link (BPL) may be established.

For a certain bandwidth part (BWP) within a certain serving cell, the reference signal for detecting beam failure may be BWP-specific configured by a radio link monitoring setting (e.g., radioLinkMonitoringConfig). The radio link monitoring setting may indicate the reference signals for detecting beam failure in a list of beam failure detection resources (e.g., a failureDetectionResourcesToAddModList). The list of beam failure detection resources may have a set q̅₀ of at most two periodical CSI-RS or SSB resource indexes. The UE may expect the set q̅₀ to have at most two single port CSI-RS/SSB resources, and the UE may expect to only be configured with periodic reference signals (e.g., CSR-RS or SSB) for beam failure detection. If the beam failure detection reference signal is a CSI-RS, the UE may expect the CSI-RS to only have single port.

If the list of beam failure detection resources is absent from the radio link monitoring setting, the UE may determine the set q̅₀ to include periodic CSI-RS resource indexes indicated by a transmission configuration indicator (TCI) state for respective control resource sets (CORSETs) used for monitoring the PDCCH. If there are two reference signal indexes in a TCI state, the UE may determine the set q̅₀ to include the reference signal indexes associated with a quasi co-location (QCL) assumption for a spatial reception parameter (e.g., QCL-TypeD).

### Aspects Related to Cross-Frequency Channel State Information

Certain aspects of the present disclosure provide methods and apparatus for cross-frequency channel state information (CSI) and/or beam failure detection (BFD). For example, a UE may monitor a first set of reference signals in a first frequency range and report CSI for a second set of reference signals in a second frequency range based on measurements of the first set of reference signals. In some cases, the UE may detect a beam failure associated with the second set of reference signals based on measurements of the first set of reference signals, and the UE may transmit a beam failure recovery request in response to the beam failure. In certain cases, the first set of resource may be in FR1, and the second set of resources may be in FR2. In certain aspects, machine learning may be used to determine the CSI/BFD for cross-frequency resources, as further described herein. In some cases, machine learning may allow the UE to determine cross-frequency CSI/BFD.

In certain aspects, the CSI may include channel characteristics and/or interference characteristics associated with the FR2 resources based on measurements of channel measurement (CM) resources and/or interference measurement (IM) resources in FR1. For model training, the UE may perform local training of machine learning models to allow for federated learning. For model training, the cross-frequency CSI may allow for network-side model training as further described herein.

The cross-frequency CSI/BFD described herein may enable reduced overhead, for example, due to wider FR1 beams serving more UEs compared to the narrower FR2 beams. The cross-frequency CSI/BFD described herein may enable flexible scheduling of the CSI/BFD, for example, due to the FR1 beams being transmitted via FDM and/or CDM. The cross-frequency CSI/BFD described herein may enable efficient power consumption at the UE, for example, due to receiving FR1 beams consuming less power than receiving FR2 beams.

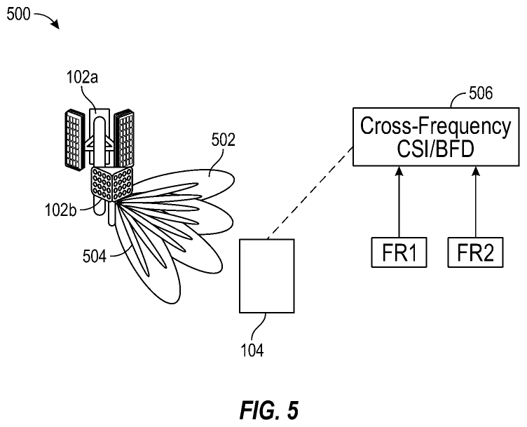

FIG. 5 is a diagram illustrating an example wireless communication network 500 with cross-frequency CSI/BFD. In this example, the UE 104 may communicate with a first BS 102a in a first frequency range (e.g., FR1) and a second BS 102b in a second frequency range (e.g., FR2). The first BS 102a may have a transceiver unit (TxRU) at the first frequency range, and the second BS 102b may have a TxRU at the second frequency range. Although depicted as being collocated, the first and second BSs 102a, 102b may be non-collocated, and there may be multiple base stations in the first frequency range as further described herein. The collocation of the first and second BSs 102a, 102b may refer to the first and second BSs 102a, 102b being set or arranged in a same place or position or integrated in a same base station or network entity. In some cases, the second BS 102b may be arranged within the cell coverage of the first BS 102a for the first and second BSs 102a, 102b to be considered collocated with each other.

The first BS 102a may communicate via a first set of beams 502, and the second BS 102b may communicate via a second set of beams 504. As further described herein, the UE 104 may determine CSI associated with the second set of beams 504 based at least in part on measurements of the first set of beams 502. In some cases, the UE 104 may detect a beam failure associated with at least one of the beams in the second set of beams 504 based at least in part on measurements of the first set of beams 502.

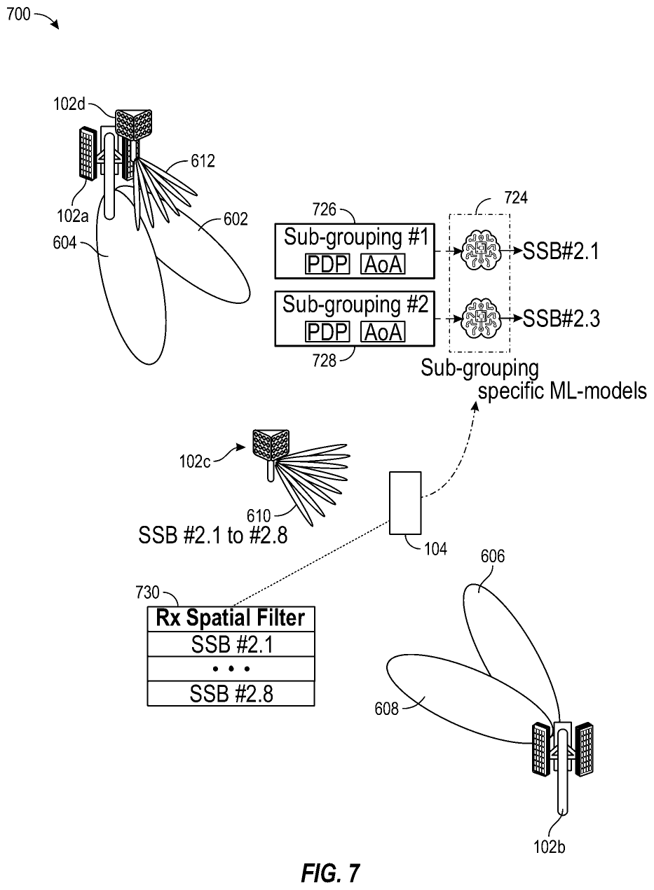

As an example, the UE 104 may use a machine learning model to determine CSI and/or detect beam failure for the second set of beams 504 based on signals received via the first set of beams 502, for example, as further described herein with respect to FIG. 7. The UE 104 may also occasionally supplement the input of the machine learning model with signals received via the second set of beams 504. The machine learning model input may include signals received on the first set of beams 502, and in some cases, signals received via the second set of beams 504, which may be measured less frequently than the first set of beams 502 for CSI and/or BFD. The UE 104 may train the machine learning model with signals received on the second set of beams 504.

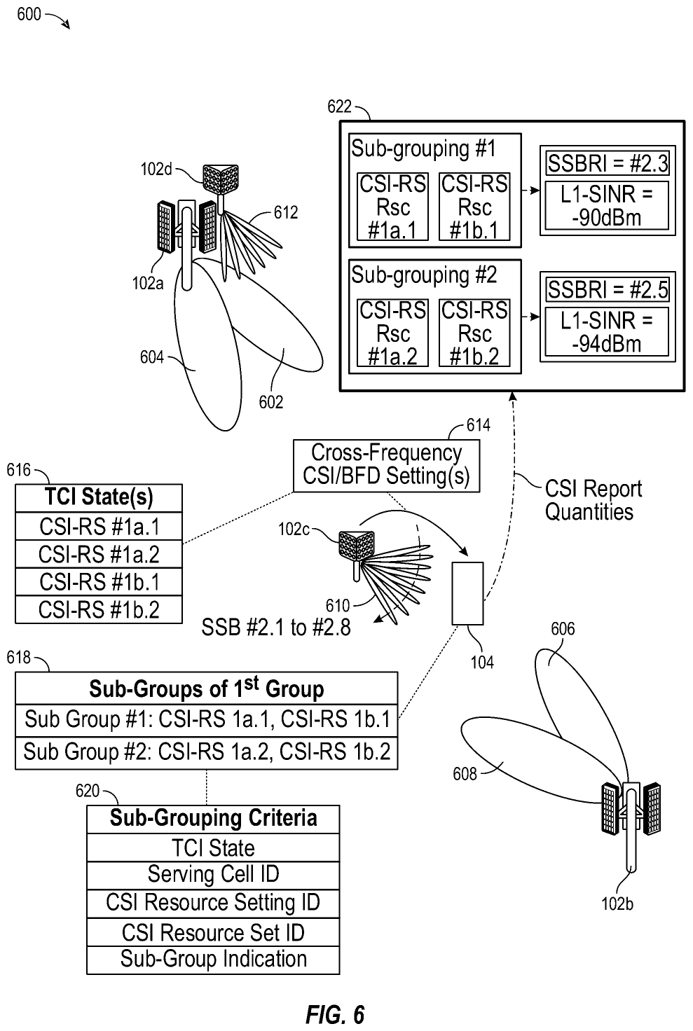

In some cases, the machine learning model may be trained with inputs of a power delay profile (PDP) and/or an angle of arrival (AoA) associated with the first set of beams 502, and the machine learning model may output beam selections or channel characteristics associated with the second set of beams 504. The PDP/AoA inputs may serve as fingerprints for the machine learning model, for example, as further described herein with respect to FIG. 7. As further described herein with respect to FIG. 6, the first set of beams 502 may be associated with multiple transmission-reception points (TRPs), multi-paths may provide enhanced resolution and/or resolve uncertainties in determining CSI/BFD associated with the second set of beams 504. Some TRPs may also be used to emulate or represent interference. For example, if an interfering FR2 BS (e.g., the second BS 102b) is collocated with an FR1 counterpart BS (e.g., the first BS 102a), the FR1 signals can be used to mimic the FR2 interference, where the UE can measure some FR1 signals as interference and measure other FR1 signals for channel estimation to predict the signal quality (e.g., signal-to-interference plus noise ratio (SINR)) in FR2, as further described herein with respect to FIG. 6.

FIG. 6 is a diagram illustrating another example wireless communication network 600 with cross-frequency CSI and/or BFD. In this example, the UE 104 may communicate with a first BS 102a in a first frequency range (e.g., FR1), a second BS 102b in the first frequency range, a third BS 102c in a second frequency range (e.g., FR2), and a fourth BS 102d in the second frequency range. The first BS 102a may communicate via a first set of beams, such as a first CSI-RS resource 602 (CSI-RS resource #1a.1) and a second CSI-RS resource 604. The second BS 102b may communicate via a second set of beams, such as a third CSI-RS resource 606 (CSI-RS resource #1b.1) and a fourth CSI-RS resource 608 (CSI-RS resource #1b.2). The third BS 102c may communicate via a third set of beams, such as SSBs 610 (SSB #2.1 through SSB #2.8). The fourth BS 102d may communicate via a fourth set of beams 612. The first BS 102a and the second BS 102b may be configured in a first cell group (e.g., a master cell group (MCG)), and the third BS 102c may be configured in a second cell group (e.g., a secondary cell group (SCG)).

In certain cases, the UE 104 may encounter interference from the fourth BS 102d, for example, when the UE 104 is communicating with the third BS 102c and the fourth BS 102d is transmitting signals in the second frequency range. In some cases, the fourth BS 102d may not be a serving cell for the UE 104. In certain aspects, the first BS 102a may be collocated with the fourth BS 102d, such that transmissions from the first BS 102a may be indicative of FR2 interference from the fourth BS 102d at the UE 104, when the UE 104 is communicating with the third BS 102c. The transmissions from the first BS 102a may be considered to mimic (or be similar to) interference from the fourth BS 102d at the UE 104.

The UE 104 may receive cross-frequency CSI/BFD setting(s) 614 indicating, for example, the specific resources to use for determining the cross-frequency CSI/BFD. The cross-frequency CSI/BFD setting(s) 614 may indicate a first group of resources associated with the first cell group (e.g., in FR1) and indicate a second group of resources associated with the second cell group (e.g., in FR2), where the first group of resources includes the first CSI-RS resource 602 through the fourth CSI-RS resource 608, and the second group of resources includes the SSBs 610. In aspects, the first group of resources may include CSI-RS resources, CSI interference measurement (CSI-IM) resources, SSB resources, or any combination thereof. The second group of resources may include CSI-RS resources, SSB resources, or a combination thereof. The first group of resources may be associated with one or more serving cells (e.g., the BSs 102a, 102b) in the first cell group, and the second group of resources may be associated with a serving cell (e.g., the BS 102c) in the second cell group.

In some cases, the cross-frequency CSI/BFD setting(s) 614 may indicate quasi co-location (QCL) assumptions associated with the various resources. For example, the cross-frequency CSI/BFD setting(s) 614 may indicate the QCL assumptions associated with the first group of resources. A QCL assumption may include a frequency dispersion assumption, a time dispersion assumption, and/or a spatial assumption. A QCL assumption may be indicated via a transmission configuration indicator (TCI) state, as shown. As shown, the cross-frequency CSI/BFD setting(s) 614 may indicate the TCI states 616 associated with the first group of resources. Some of the resources in the first group of resources may have the same TCI states.

In certain aspects, the first group of resources (all or some) may be arranged in sub-groups 618. For example, a first sub-group may include the first CSI-RS resource 602 and the third CSI-RS resource 606, and a second sub-group may include the second CSI-RS resource 604 and the fourth CSI-RS resource 608. The first sub-group may be used to determine channel characteristics and/or beam failure associated with the SSB #2.3 among the SSBs 610, and the second sub-group may be used to determine channel characteristics and/or beam failure associated with the SSB #2.5 among the SSBs 610. Each of the sub-groups may represent a CSI/BFD hypothesis associated with at least one of the resources in the second group of resources. The CSI/BFD hypothesis may refer to a set of the first group of resources used to determine CSI and/or beam failure for a certain resource in the second group of resources. Different sub-groups of the first group of resources can be representative of a different signal-interference and/or beam failure hypothesis associated with at least one of the resources in the second group of resources. For example, an FR1 resource may be used to mimic FR2 interference, such as the first and second CSI-RS resources 602, 604 mimicking the FR2 interference from the fourth BS 102d. The FR1 resource may be indicative of FR2 interference encountered at a UE. For example, the first and second CSI-RS resources 602, 604 may be indicative of interference from the fourth BS 102d at the UE 104.

The resources for each of the sub-groups may be selected based on various criteria. For example, the first group of resources may be arranged in sub-groups based on one or more sub-grouping criteria 620 including a TCI state, a serving cell identifier (ID), a CSI resource setting ID, a CSI resource set ID, a sub-group indication, or any combination thereof. Resources with different TCI states or the same TCI state may be arranged in a sub-group. Resources associated with different serving cells or the same serving cell, for example, based on serving cell IDs, may be arranged in a sub-group. Resources with different CSI resource setting IDs or the same CSI resource setting ID may be arranged in a sub-group. Resources from different CSI resource sets or from the same CSI resource set, for example, based on the corresponding CSI resource set ID, may be arranged in a sub-group. In some cases, the UE 104 may receive an explicit indication of the sub-groups (e.g., an explicit pre-grouping indication) to use among the first group of resources. In certain cases, CSI-RS, CSI-IM, and/or SSB resources of the first group of resources may be pre-grouped into multiple sub-groups.

In certain aspects, a sub-group may include only channel measurement resources or a combination of channel measurement resources and interference measurement resources. In some cases, all of the CSI-RS/SSB resources in the sub-groups may be channel measurement resources. In certain cases, some of the CSI-RS/SSB resources in a sub-group may be interference measurement resources.

In certain cases, each sub-group may be associated with a particular sub-group index. The sub-group index may be associated with and indicate the constituent resources of the sub-group. The sub-group index may be reported to the network. In some cases, the constituent resources of a sub-group may also be reported to the network. The UE may report each of the sub-group indices via channel state information resource indicators (CRIs) and/or SSB resource indicators (SSBRIs) associated with the constituent resources of the sub-groups. In some cases, the UE may report one or more CRIs/SSBs, where each of the CRIs/SSBs is representative of a single sub-group index. The combinations of multiple CSI-RS or SSB resources may be indicated by a single CRI/SSBRI. The codepoints of the CRIs/SSBRIs and/or sub-group indices may be predefined or preconfigured. In certain cases, the respective CRIs/SSBRIs may indicate the resources selected with regard to a specific sub-group index. For example, the UE may report all of the CRIs/SSBRIs of the sub-groups, and the network may be able to derive the corresponding sub-group indices based on the CRIs/SSBRIs.

For certain aspects, the UE 104 reports CSI 622 (or requests a beam failure recovery) associated with the second group of resources based on channel measurements associated with the first group of resources. For example, the CSI 622 may include the Layer-1 SINR associated with SSB #2.3 and the Layer-1 SINR associated with SSB #2.5. Reporting properties associated with multiple resources in the second cell group may enable improved wireless communications. For example, the third BS 102c can trigger actual measurements of the SSBs 610 in response to the CSI 622. The third BS 102c can trigger a reconfiguration of the beams used for communicating with the UE 104 in response to the CSI 622.

The cross-frequency CSI may facilitate reduced overhead, latency, and/or power consumption at the UE 104, as described herein. For example, the first group of resources may have a larger coverage area compared to the second group of resources, such that the first group of resources may reach more UEs compared to the second group of resources enabling reduced overhead. The UE 104 may also consume less power monitoring for the first group of resources compared to similar efforts to monitor the second group of resources.

In certain aspects, a machine learning model may be used to determine the CSI and/or detect the beam failure associated with beams in FR2 based on measurements of beams in FR1. For example, a machine learning model may take as input PDP and/or AoAs associated with beams in FR1, as further described herein.

FIG. 7 is a diagram illustrating another example wireless communication network 700 where the UE 104 may use machine learning for processing cross-frequency CSI/BFD. In this example, the UE 104 may be configured with one or more machine learning models 724 used to predict CSI and/or to detect a beam failure associated with the SSBs 610 based on channel measurements or certain properties associated with the first group of resources (e.g., the CSI-RS resources 602-608). In certain aspects, the UE 104 may use a different machine learning model for each of the hypothesis sub-groups of the first group of resources. Each of the machine learning models may be specific to a hypothesis sub-group of the first group of resources.

The input 726, 728 to the machine learning model(s) 724 may include PDP(s) and/or AoA(s) associated with the hypothesis sub-group(s) among the first group of resources, where the. For example, the first input 726 may include properties (e.g., PDP and/or AoA) associated with a first sub-group of the CSI-RS resources 602-608, such as the first CSI-RS resource 602 and the third CSI-RS resource 606. The second input 728 may include properties associated with a second sub-group of the CSI-RS resources 602-608, such as the second CSI-RS resource 604 and the fourth CSI-RS resource 608.

The output of the machine learning model(s) 724 may include possibilities of each of the CSI-RS or SSB resources within the second group of resources being the resource maximizing spectral efficiency (SE), RSRP, and/or SINR in the serving cell (e.g., the BS 102c) of the second cell group. The output of the machine learning model(s) 724 may include an indication of which of the CSI-RS or SSB resources in the second group provide the greatest SE, RSRP, and/or SINR. The output of the machine learning model(s) 724 may include a Layer-1 RSRP (L1-RSRP), a Layer-1 SINR (L1-SINR), a rank indicator (RI), a channel quality indicator (CQI), or a precoding matrix indicator (PMI), or any combination thereof associated with a particular CSI-RS or SSB resource within the second group of resources (e.g., SSB #2.1 or SSB #2.3).

In certain aspects, multiple machine learning models and/or multiple sets of machine learning model parameters can be configured. For example, each model or each set of parameters may be associated with a certain hypothesis sub-group selection in the first group of resources, or associated with a certain CSI-RS or SSB resource within the second group of resources.

In certain aspects, federated learning may be used at the UE 104 with the machine learning model(s) 724. For example, the UE 104 may receive a shared machine learning model from the network. The UE 104 may locally train the machine learning model and feedback information associated with the trained machine learning model to the network, such as changes made to the machine learning models due to the local training. The network may use the information to update the shared machine learning model, and the network may configure the UE 104 and/or other UEs with the updated machine learning model.

In certain cases, the network may indicate to the UE 104 to locally train the machine learning model(s) 724 for cross-frequency CSI/BFD. The training task may be linked with the first and second group of resources. The UE 104 may directly determine one or more group(s) of SSBRI, CRI, L1-RSRP, L1-SINR, RI, CQI, and/or PMI associated with the second group of resources, based on channel measurements of the second group of resources. The properties determined may be used as ground-truth labels for training the machine learning model(s) 724. The UE 104 may also determine reception spatial filters 730 associated with the second group of resources based on the first group of resources, such as the hypothesis sub-groups selected for the cross-frequency CSI/BFD. The reception spatial filters 730 may be used to determine properties associated with the second group of resources, such as SSBRI, CRI, L1-RSRP, L1-SINR, RI, CQI, and/or PMI. The UE 104 may take respective input options associated with certain sub-groups of the first group of resources, and the UE 104 may use the ground-truth labels associated with the same sub-groups to locally train the machine learning model(s) 724. The UE 104 may feedback the locally trained machine learning model(s) 724 to the network to allow for federated learning.

In certain aspects, various machine learning models may be locally trained at the UE 104. For example, machine learning models associated with certain hypothesis sub-groups of the first group of resources may be trained. In some cases, machine learning models associated with certain resources in the second group of resources may be trained, where the respective ground-truth labels are used.

The network may train the machine learning models 724 used at the UE 104. In some cases, the network may use machine learning models for various functions, such as beamforming, scheduling, and/or configuring the link between a UE and the network (e.g., adaptive modulation and coding). For example, the UE 104 may report, to the network, properties associated with the second group of resources based on measurements associated with the second group of resources, where the properties may include SSBRI, CRI, L1-RSRP, L1-SINR, RI, CQI, PMI, or any combination thereof. The network may use the properties associated with the second group of resources to train the machine learning models used at the network and/or UE. In some cases, the UE 104 may report the reception spatial filters 730 to the network, and the network may train the machine learning models used at the network and/or UE based on the reception spatial filters 730.

In certain cases, the UE 104 may report, to the network, one or more channel characteristics (e.g., PDP and/or AoA) associated with the hypothesis sub-groups of the first group of resources. The network may train the machine learning models used at the network and/or UE with the channel characteristics associated with the hypothesis sub-groups. In some cases, the UE may report the channel characteristics associated with all possible sub-groups of the first group of resources. In such cases, the UE may refrain from using sub-group indices to report the channel characteristics. For example, the channel characteristics may be arranged in an order representative of the corresponding sub-groups.

In certain aspects, the cross-frequency CSI/BFD settings (e.g., the settings 614) may be conveyed via a CSI reporting setting, a CSI resource setting, and/or a CSI resource set. The cross-frequency resource groups may be indicated in a CSI resource setting with multiple resource sets. For example, the first group of resources (e.g., FR1 resources) may be indicated via one or more first CSI resource settings (e.g., CSI-ResourceConfig) and/or one or multiple CSI resource sets (e.g., CSI-ResourceSet) associated with the CSI resource setting(s), where the first CSI resource setting(s) may be associated with serving cell(s) in a first cell group in a first frequency range (e.g., FR1). The second group of resources (e.g., FR2 resources) may be indicated via a second CSI resource setting associated with a serving cell in a second cell group in a second frequency range (e.g., FR2).

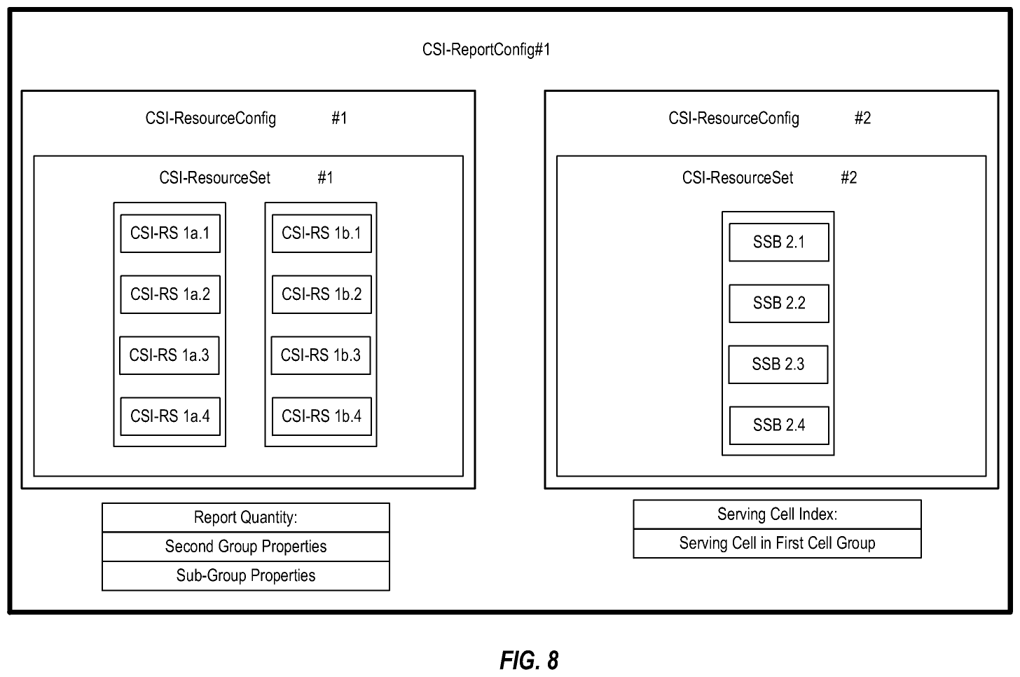

FIG. 8 is a diagram illustrating an example CSI report setting that indicates cross-frequency resources via a CSI resource set. In this example, a CSI report setting (e.g., CSI-ReportConfig #1) may be associated with multiple CSI resource settings (e.g., CSI-ResourceConfig #1 and CSI-ResourceConfig #2), where the first CSI resource setting (CSI-ResourceConfig #1) may indicate the cross-frequency CSI/BFD resources associated with a first cell group (e.g., the BSs 102a, 102b in FIG. 6) in a first frequency range, and the second CSI resource setting may indicate the cross-frequency CSI/BFD resource associated with a second cell group (e.g., the BS 102c in FIG. 6). A first CSI resource set (CSI-ResourceSet #1) associated with the first CSI resource setting may indicate CSI-RS resources 1a.1 through 1a.4 associated with a first serving cell (e.g., the first BS 102a in FIG. 6) in a first cell group and indicate CSI-RS resources 1b.1 through 1b.4 associated with a second serving cell (e.g., the second BS 102b in FIG. 6) in the first cell group. A second CSI resource set (CSI-ResourceSet #2) associated with the second CSI resource setting may indicate SSB resources 2.1 through 2.4 may be associated with a third serving cell (e.g., the third BS 102c in FIG. 6) in a second cell group.

In some cases, the CSI report setting may indicate the properties included in the CSI feedback to be reported to the network, for example, via a report quantity field. For example, the report quantity field may indicate one or more properties associated with second group of resources. The properties may include SSBRI, CRI, L1-RSRP, L1-SINR, RI, CQI, PMI, or any combination thereof, for example. In certain cases, the report quantity field may indicate one or more properties associated with the sub-groups of the first group of resources. The report quantity field may identify each of the sub-group via a sub-group index associated with a set of properties. The UE may interpret the report quantity field to indicate the CSI feedback to report for the second group of resources (e.g., SSB resources 2.1 through 2.4) based on measurements of the first group of resources.

In certain aspects, the cross-frequency CSI/BFD settings may indicate which serving cell to use for reporting the CSI. For example, the cross-frequency CSI/BFD settings may indicate to report the CSI via one or more serving cells in the first frequency range (e.g., FR1). In some cases, the cross-frequency CSI/BFD settings may indicate to report the CSI via a serving cell in the second frequency range (e.g., FR2). Referring to FIG. 8, the CSI report setting may include a field (e.g., a serving cell index field) that indicates which serving cell to use for reporting the CSI. In this example, the serving cell index field may indicate to use a serving cell (e.g., the first BS 102a) in the first cell group to report the CSI. The first CSI resource setting and the second CSI resource setting may be configured by a CSI report setting, which may be defined in one or more of the serving cells in the first cell group. The respective serving cell identifiers (e.g., serving cell index) may be included in the CSI report setting. In some cases, the first CSI resource setting(s) and the second CSI resource setting may be indicated by a CSI report setting (e.g., CSI-ReportConfig), which may be defined in the second serving cell.

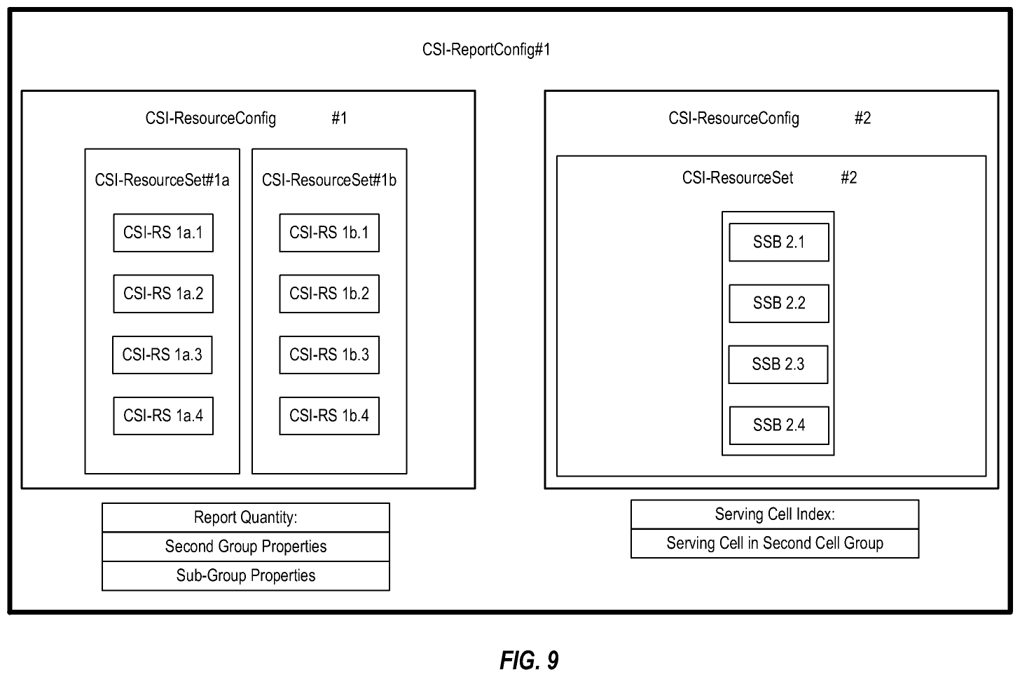

FIG. 9 is a diagram illustrating an example CSI report setting that indicates cross-frequency resources via separate CSI resource sets for each of the serving cells. In this example, the first CSI resource setting (CSI-ResourceConfig #1) associated with a CSI report setting (CSI-ReportConfig #1) may identify the first group of resources via a first CSI resource set (CSI-ResourceSet #1a) and a second resource set (CSI-ResourceSet #1b), where the first CSI resource set is associated with a first serving cell (e.g., the first BS 102a in FIG. 6) in a first cell group, and the second CSI resource is associated with a second serving cell (e.g., the second BS 102b in FIG. 6) in the first cell group. The second CSI resource setting may identify the second group of resources via a third CSI resource set (CSI-ResourceSet #2). The serving cell index field may also indicate to use a serving cell (e.g., the third BS 102c) in the second cell group to report the CSI.

In certain aspects, the serving cell in the second cell group may have multiple TRPs. In some cases, the second group of resources in the second frequency range (e.g., FR2) may be further divided into multiple sub-groups, where each of the sub-groups is associated with a different TRP of the second serving cell.

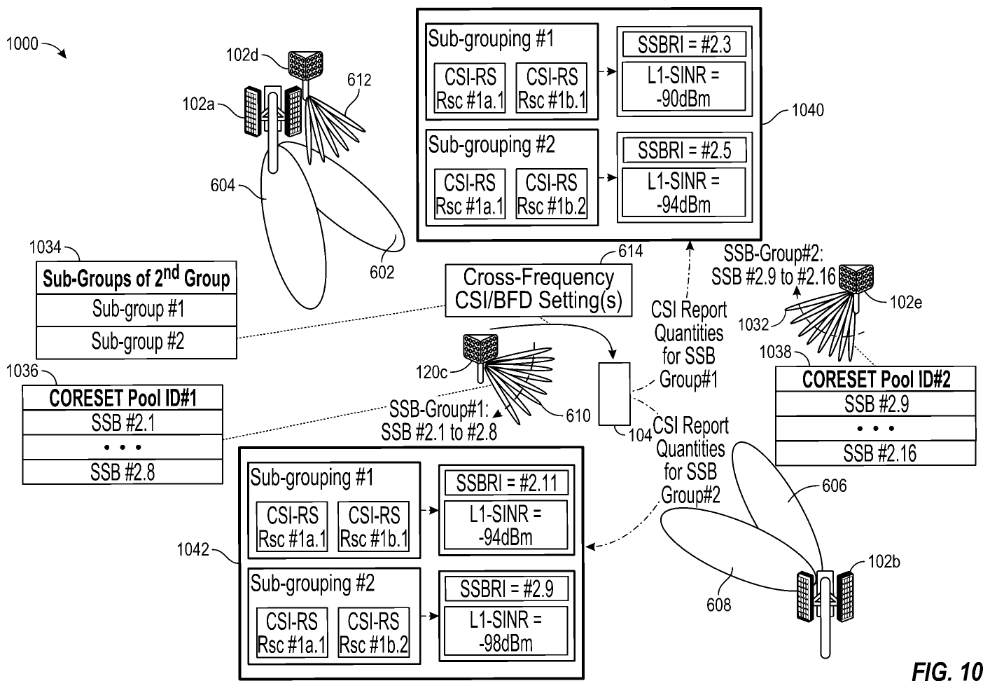

FIG. 10 is a diagram illustrating an example wireless communication network 1000 where the serving cell in the second cell group has multiple TRPs. In this example, the serving cells in the first cell group include the first BS 102a and the second BS 102b. The serving cell in the second cell group may include the third BS 102c and a fifth BS 102e, which may communicate via a fifth set of beams, such as second SSBs 1032. The third BS 102c and the first BS 102e may representative of different TRPs associated with the serving cell in the second cell group. As described herein, transmissions from the first BS 102a may be indicative of FR2 interference from the fourth BS 102d at the UE 104.

The cross-frequency CSI/BFD setting(s) 614 may indicate sub-groups 1034 among the second group of resources (e.g., SSBs 610, 1032). For example, the sub-groups among the second group of resources may include a first sub-group (sub-group #1) including the first SSBs 610 associated with the third BS 102c and a second sub-group (sub-group #2) including the second SSBs 1032 associated with the fifth BS 102e. The sub-groups among the second group of resources may be indicated via a CSI resource setting, a CSI resource set, a sub-group identifier, or a combination thereof.

In certain aspects, the resources for each TRP of the second serving cell may be associated with a particular control resource set (CORESET) pool. Referring to FIG. 10, the first SSBs 610 may be associated with a first CORESET pool 1036, and the second SSB 1032 may be associated with a second CORESET pool 1038. A particular CORESET pool identifier may be associated with each of the CORESET pools 1036, 1038.

The UE 104 may select which of the resources in the second group of resources to report CSI and/or beam failure. The UE 104 may select and report a certain CSI-RS or SSB resource from each of the multiple sub-groups of the second group of resources. For example, the CSI feedback may include first channel characteristics 1040 associated with SSB 2.3 and SSB 2.5 in the first sub-group and second channel characteristics 1042 associated with SSB 2.11 and SSB 2.9 in the second sub-group.

A non-adaptive algorithm is deterministic as a function of its inputs. If the algorithm is faced with exactly the same inputs at different times, then its outputs will be exactly the same. An adaptive algorithm (e.g., machine learning or artificial intelligence) is one that changes its behavior based on its past experience. This means that different devices using the adaptive algorithm may end up with different algorithms as time passes.

According to certain aspects, the cross-frequency CSI/BFD procedures may be performed using an adaptive learning-based algorithm (e.g., the machine learning models 724). Thus, over the time, the cross-frequency CSI/BFD algorithm changes (e.g., adapts or updates) based on new learning. The cross-frequency CSI/BFD procedures may be used for adapting various characteristics of the communication link between a UE and a network entity, such as transmit power control, modulation and coding scheme(s), code rate, subcarrier spacing, etc. For example, the adaptive learning can be used to determine CSI for resources in a first frequency range based on measurements of resources in a second frequency range described herein.

In some examples, the adaptive learning-based cross-frequency CSI/BFD involves training a model, such as a predictive model. The model may be used to determine cross-frequency CSI/BFD associated with reference signals in a first frequency range based on measurements of reference signals in a second frequency range. The model may be trained based on training data (e.g., training information), which may include feedback, such as feedback associated with the cross-frequency CSI/BFD (e.g., measurements of reference signals in the first frequency range).

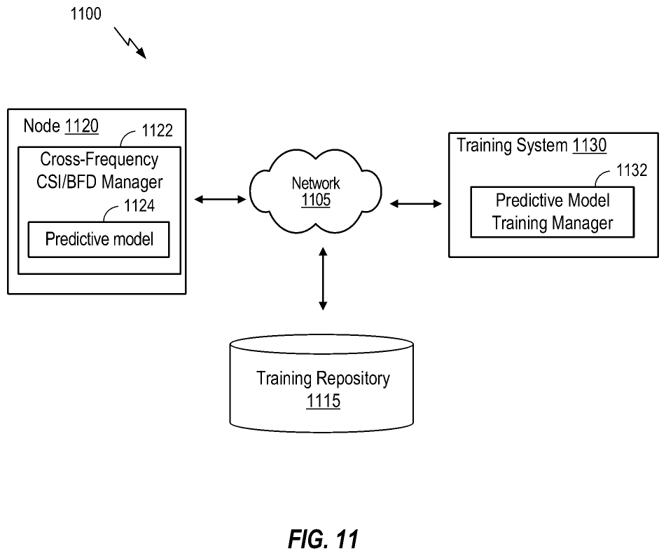

FIG. 11 illustrates an example networked environment 1100 in which a predictive model 1124 is used for cross-frequency CSI/BFD. As shown in FIG. 11, networked environment 1100 includes a node 1120, a training system 1130, and a training repository 1115, communicatively connected via network 1105. The node 1120 may be a UE (e.g., such as the UE 104 in the wireless communication network 100) or a BS (e.g., such as the BS 102 in the wireless communication network 100). The network 1105 may be a wireless network such as the wireless communication network 100, which may be a 5G NR network. While the training system 1130, node 1120, and training repository 1115 are illustrated as separate components in FIG. 11, it should be recognized by one of ordinary skill in the art that the training system 1130, node 1120, and training repository 1115 may be implemented on any number of computing systems, either as one or more standalone systems or in a distributed environment.

The training system 1130 generally includes a predictive model training manager 1132 that uses training data to generate a predictive model 1124 for cross-frequency CSI/BFD based on measurements associated with resources in a specific frequency range. The predictive model 1124 may be determined based on the information in the training repository 1115.

The training repository 1115 may include training data obtained before and/or after deployment of the node 1120. The node 1120 may be trained in a simulated communication environment (e.g., in field testing, drive testing, etc.) prior to deployment of the node 1120. For example, various cross-frequency CSI/BFD results (e.g., SSBRI, CRI, L1-RSRP, L1-SINR, RI, CQI, PMI etc.) can be tested in various scenarios, such as with different CM/IM resource pairs, different CM/IM resources, at different UE speeds, with the UE stationary, at various rotations/positions of the UE, with various BS deployments/geometries, etc., to obtain training information related to the cross-frequency CSI/BFD procedure. This information can be stored in the training repository 1115. After deployment, the training repository 1115 can be updated to include feedback associated with cross-frequency CSI/BFD procedures performed by the node 1120. The training repository can also be updated with information from other BSs and/or other UEs, for example, based on learned experience by those BSs and UEs, which may be associated with cross-frequency CSI/BFD procedures performed by those BSs and/or UEs.

The predictive model training manager 1132 may use the information in the training repository 1115 to determine the predictive model 1124 (e.g., algorithm) used for cross-frequency CSI/BFD, such as to determine SSBRI, CRI, L1-RSRP, L1-SINR, RI, CQI, PMI, etc. As discussed in more detail herein, the predictive model training manager 1132 may use various different types of adaptive learning to form the predictive model 1124, such as machine learning, deep learning, reinforcement learning, etc. The training system 1130 may adapt (e.g., update/refine) the predictive model 1124 over time. For example, as the training repository is updated with new training information (e.g., feedback), the model 1124 is updated based on the new learning/experience.

The training system 1130 may be located on the node 1120, on a BS in the network 1105, or on a different entity that determines the predictive model 1124. If located on a different entity, then the predictive model 1124 is provided to the node 1120.

The training repository 1115 may be a storage device, such as a memory. The training repository 1115 may be located on the node 1120, the training system 1130, or another entity in the network 1105. The training repository 1115 may be in cloud storage. The training repository 1115 may receive training information from the node 1120, entities in the network 1105 (e.g., BSs or UEs in the network 1105), the cloud, or other sources.

As described above, the node 1120 is provided with (or generates, e.g., if the training system 1130 is implemented in the node 1120) the predictive model 1124. As illustrated, the node 1120 may include a cross-frequency CSI/BFD manager 1122 configured to use the predictive model 1124 for cross-frequency CSI/BFD based on measurements associated with resources in a specific frequency range described herein. In some examples, the node 1120 utilizes the predictive model 1124 to generate cross-frequency CSI/BFD based on the measurements associated with resources in a specific frequency range. The predictive model 1124 is updated as the training system 1130 adapts the predictive model 1124 with new learning.

Thus, the cross-frequency CSI/BFD algorithm, using the predictive model 1124, of the node 1120 is adaptive learning-based, as the algorithm used by the node 1120 changes over time, even after deployment, based on experience/feedback the node 1120 obtains in deployment scenarios (and/or with training information provided by other entities as well).

According to certain aspects, the adaptive learning may use any appropriate learning algorithm. As mentioned above, the learning algorithm may be used by a training system (e.g., such as the training system 1130) to train a predictive model (e.g., such as the predictive model 1124) for an adaptive-learning based cross-frequency CSI/BFD algorithm used by a device (e.g., such as the node 1120) for determining cross-frequency CSI/BFD based on measurements of resources in a specific frequency range described herein. In some examples, the adaptive learning algorithm is an adaptive machine learning algorithm, an adaptive reinforcement learning algorithm, an adaptive deep learning algorithm, an adaptive continuous infinite learning algorithm, or an adaptive policy optimization reinforcement learning algorithm (e.g., a proximal policy optimization (PPO) algorithm, a policy gradient, a trust region policy optimization (TRPO) algorithm, or the like). In some examples, the adaptive learning algorithm is modeled as a partially observable Markov Decision Process (POMDP). In some examples, the adaptive learning algorithm is implemented by an artificial neural network (e.g., a deep Q network (DQN) including one or more deep neural networks (DNNs)).

In some examples, the adaptive learning (e.g., used by the training system 1130) is performed using a neural network. Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

In some examples, the adaptive learning (e.g., used by the training system 1130) is performed using a deep belief network (DBN). DBNs are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input could be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

In some examples, the adaptive learning (e.g., used by the training system 1130) is performed using a deep convolutional network (DCN). DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods. DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

An artificial neural network, which may be composed of an interconnected group of artificial neurons (e.g., neuron models), is a computational device or represents a method performed by a computational device. These neural networks may be used for various applications and/or devices, such as Internet Protocol (IP) cameras, Internet of Things (IoT) devices, autonomous vehicles, and/or service robots. Individual nodes in the artificial neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation.” The weight values may initially be determined by an iterative flow of training data through the network (e.g., weight values are established during a training phase in which the network learns how to identify particular classes by their typical input data characteristics).

Different types of artificial neural networks can be used to implement adaptive learning (e.g., used by the training system 1130), such as recurrent neural networks (RNNs), multilayer perceptron (MLP) neural networks, convolutional neural networks (CNNs), and the like. RNNs work on the principle of saving the output of a layer and feeding this output back to the input to help in predicting an outcome of the layer. In MLP neural networks, data may be fed into an input layer, and one or more hidden layers provide levels of abstraction to the data. Predictions may then be made on an output layer based on the abstracted data. MLPs may be particularly suitable for classification prediction problems where inputs are assigned a class or label. Convolutional neural networks (CNNs) are a type of feed-forward artificial neural network. Convolutional neural networks may include collections of artificial neurons that each has a receptive field (e.g., a spatially localized region of an input space) and that collectively tile an input space. Convolutional neural networks have numerous applications. In particular, CNNs have broadly been used in the area of pattern recognition and classification. In layered neural network architectures, the output of a first layer of artificial neurons becomes an input to a second layer of artificial neurons, the output of a second layer of artificial neurons becomes an input to a third layer of artificial neurons, and so on. Convolutional neural networks may be trained to recognize a hierarchy of features. Computation in convolutional neural network architectures may be distributed over a population of processing nodes, which may be configured in one or more computational chains. These multi-layered architectures may be trained one layer at a time and may be fine-tuned using back propagation.

In some examples, when using an adaptive machine learning algorithm, the training system 1130 generates vectors from the information in the training repository 1115. In some examples, the training repository 1115 stores vectors. In some examples, the vectors map one or more features to a label. For example, the features may correspond to various deployment scenario patterns discussed herein, such as the UE mobility, speed, rotation, position, channel conditions, BS deployment/geometry in the network, etc. The label may correspond to the cross-frequency CSI/BFD (e.g., SSBRI, CRI, L1-RSRP, L1-SINR, RI, CQI, PMI, etc.) associated with the features for performing cross-frequency CSI/BFD (e.g., UE mobility, speed, rotation, channel conditions, etc.). The predictive model training manager 1132 may use the vectors to train the predictive model 1124 for the node 1120. As discussed above, the vectors may be associated with weights in the adaptive learning algorithm. As the learning algorithm adapts (e.g., updates), the weights applied to the vectors can also be changed. Thus, when the cross-frequency CSI/BFD procedure is performed again, under the same features (e.g., under the same set of conditions including UE mobility, speed, rotation, channel conditions, etc.), the model may give the node 1120 a different result (e.g., different SSBRI, CRI, L1-RSRP, L1-SINR, RI, CQI, PMI, etc.).

According to certain aspects, the adaptive learning based-beam management allows for continuous infinite learning. In some examples, the learning may be augmented with federated learning. For example, while some machine learning approaches use a centralized training data on a single machine or in a data center; with federated learning, the learning may be collaborative involving multiple devices to form the predictive model. With federated learning, training of the model can be done on the device, with collaborative learning from multiple devices. For example, referring back to FIG. 11, the node 1120 can receive training information and/or updated trained models, from various different devices.

### Example Operations of Entities in a Communications Network

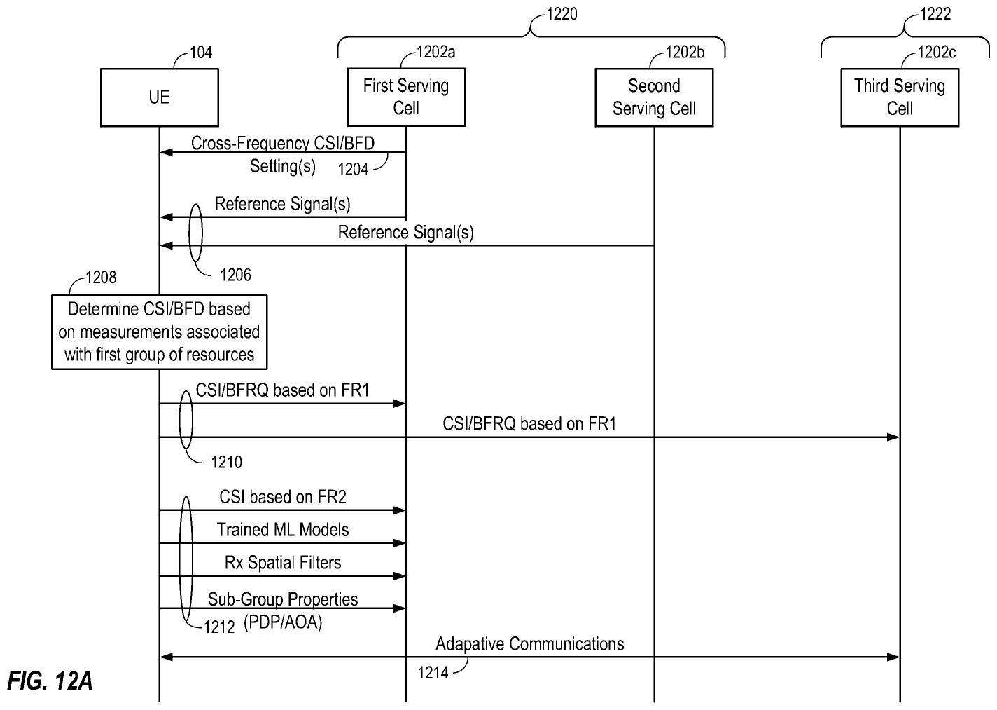

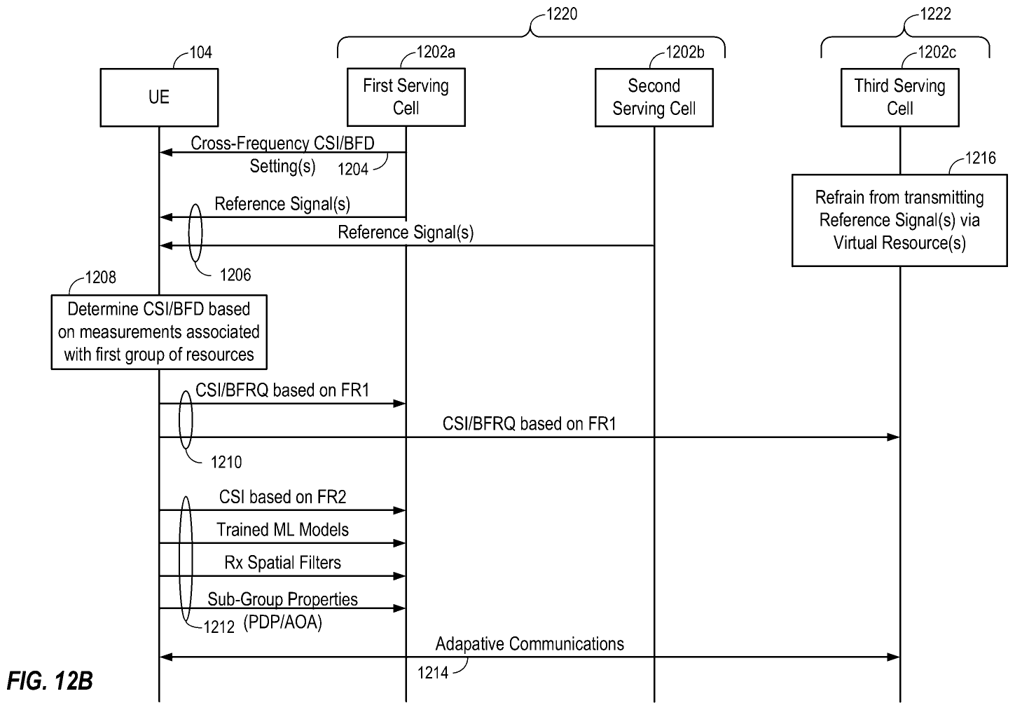

FIG. 12A is a signaling flow illustrating example operations for cross-frequency CSI/BFD. In this example, the UE 104 may communicate with a first serving cell 1202a (e.g., the first BS 102a in FIG. 6) in a first frequency range (e.g., FR1), a second serving cell 1202b (e.g., the second BS 102b in FIG. 6) in the first frequency range, and a third serving cell 1202c (e.g., the third BS 102c in FIG. 6) in a second frequency range (e.g., FR2). The first serving cell 1202a may be collocated with a fourth serving cell (e.g., the fourth BS 102d in FIG. 6) in the second frequency range, where transmissions from the first serving cell 1202a may be indicative of interference from the fourth serving cell at the UE 104. The first and second serving cells 1202a, 1202b may be associated with a first cell group 1220 (e.g., a MCG), and the third serving cell 1202c may be associated with a second cell group 1222 (e.g., a SCG).

At activity 1204, the UE 104 may receive, from the first serving cell 1202a (or any of the other serving cells 1202b, 1202c), cross-frequency CSI/BFD setting(s) (e.g., the setting(s) 614) indicating specific resources to use for determining the cross-frequency CSI/BFD. The cross-frequency CSI/BFD setting may indicate a first group of resources associated with the first cell group 1220 (e.g., in FR1) and indicate a second group of resources associated with the second cell group 1222 (e.g., in FR2). For example, the cross-frequency CSI/BFD setting may include a CSI report setting, CSI resource settings, and CSI resource sets described herein with respect to FIGS. 8 and 9. The cross-frequency CSI/BFD setting may include a report quantity field indicating certain properties to report for CSI feedback, for example, as described herein with respect to FIGS. 8 and 9. The cross-frequency CSI/BFD setting may indicate TCI states associated with the resources indicated for cross-frequency CSI/BFD as described herein.

At activity 1206, the UE 104 may receive reference signals from the first serving cell 1202a and/or the second serving cell 1202b in the first frequency range. For example, the UE 104 may monitor for the reference signals periodically and/or in response to a trigger for aperiodic CSI. The reference signals may be received via resources in the first group of resources associated with the first cell group 1220. The reference signals may include a CSI-RS and/or an SSB, for example. The reception of reference signals in the first frequency range may allow for reduced overhead (for example, due to wider FR1 beams), flexible scheduling (for example, due to CDM or FDM FR1 beams), and/or efficient power consumption at the UE 104 (for example, due to lower power consumption to receive FR1 beams) compared to reception of reference signals in the second frequency range.

At activity 1208, the UE 104 may determine CSI and/or a beam failure associated with the second group of resources based on measurements associated with the first group of resources. For example, the UE 104 may use a machine learning model for a sub-group of the first group of resources to determine the CSI associated with a particular CSI-RS or SSB of the second group of resources. The machine learning model may take as input the PDP and/or AoA associated with the sub-group in the first group of resources, for example, as described herein with respect to FIG. 7.

At activity 1210, the UE 104 may report the CSI (or request beam failure recovery) based on the measurements in the first frequency range to any of the serving cells, such as the first serving cell 1202a or the third serving cell 1202c. In certain cases, the cross-frequency CSI/BFD setting may indicate which serving cell to use for reporting CSI, for example, as described herein with respect to FIGS. 8 and 9.

At activity 1212, the UE 104 may report various information associated with the cross-frequency CSI/BFD to the network. For example, the UE 104 may transmit, to the first serving cell 1202a (or any of the other serving cells 1202b, 1202c), CSI based on measurements of the second group of resources in the second frequency range. In some cases, the UE 104 may transmit, to the first serving cell 1202a, information associated with machine learning model(s) trained locally at the UE 104 to allow for federated learning. In certain cases, the UE 104 may transmit, to the first serving cell 1202a, reception spatial filters for receiving the second group of resources determined based on the first group of resources. In some cases, the UE 104 may transmit, to the first serving cell 1202a, properties associated with sub-groups among the first group of resources, such as PDP and/or AoA associated with each of the sub-groups. The network may use the various information received from the UE 104 to train machine learning model(s) used at the network and/or the UE 104.

At activity 1214, the UE 104 may communicate with the third serving cell 1202c in the second frequency range. In certain aspects, the network may adapt the communications between the UE 104 and the third serving cell 1202c based on the CSI and/or beam failure recovery request received at activity 1210. For example, in response to the CSI and/or beam failure recovery request, the network may adjust the beam, the modulation and coding scheme (MCS), the code rate (e.g., the proportion of the data-stream that is non-redundant), the number of aggregated component carriers, the number of MIMO layers, the bandwidth, the subcarrier spacing, frequency band, or any combination thereof associated with the communication link between the UE 104 and the third serving cell 1202c.

In certain aspects, the second group of resources associated with the second cell group may be or include one or more physical resources, one or more virtual resources (which may also be referred to as logical resource(s) or nominal resource(s)), or a combination thereof. A virtual resource may include a resource (e.g., a time-frequency resource) that may not be used for certain communication(s), whereas a physical resource (in certain contexts) may include a resource that is used for communication(s), for example, transmitting and/or receiving a signal via the physical resource. A UE may be configured with a virtual resource dynamically (e.g., configured as virtual via a trigger including DCI or an event), semi-persistently (e.g., configured virtual until indicated otherwise), or permanently. As an example, a UE may be configured with a virtual resource (e.g., a virtual resource in FR2) for cross-frequency CSI to assess a property associated the resource (e.g., a channel quality, a signal quality, a signal strength, data error rate, etc.) based on measurements associated with a first group of resources (e.g., a physical resource in FR1). The UE may provide a network entity with the CSI associated with the virtual resources as described herein. In some cases, the CSI associated with the virtual resources may allow the network entity to determine if the virtual resources are suitable for communications with the UE before using such resources for actual communications. Thus, the virtual resources may allow a network entity and/or a UE to evaluate the channel conditions before allocating or using certain resources for communications.

In some cases, the virtual resource may be associated with particular communication(s) (e.g., a reference signal), not used for the particular communication(s), and used for other communication(s) (e.g., data communications and/or control signaling). For example, a UE may be configured with virtual resources for cross-frequency CSI/BFD, and the network entity may use the virtual resources for communications with other UE(s) and/or other r communications (e.g., data communications) with the UE. The network entity may reuse the virtual resources for other communications. The network entity may adapt the other communications with the other UE(s) and/or the UE based on the cross-frequency CSI associated with the virtual resources.

The cross-frequency CSI/BFD described herein may facilitate the usage of virtual resource(s) for determining and/or predicting one or more properties associated with such virtual resource(s). Such properties may include, for example, beam pointing directions (e.g., absolute, relative, explicit, or implicit directions), beam widths (or shapes), beam pointing neighboring, colocations, etc. The virtual resources may enable efficient resource allocation and/or efficient resource usage, for example, due to the virtual resources being used for other communications and/or the virtual resources being used to assess the channel conditions before using the resources for actual communications.

FIG. 12B is a signaling flow illustrating example operations for cross-frequency CSI/BFD. As shown, the same signaling and operations described herein with respect to FIG. 12A are performed with respect to FIG. 12B. In this example, the second group of resources associated with the second cell group 1222 include one or more virtual resources. At activity 1216, the third serving cell 1202c may refrain from transmitting reference signal(s) (e.g., a CSI-RS and/or an SSB) via the virtual resource(s), for example, in a transmission occasion(s) associated with the virtual resource(s). The UE 104 may refrain from receiving reference signal(s) via the virtual resource(s) in the transmission occasions associated with the virtual resource(s). In some cases, the third serving cell 1202c may use the virtual resource(s) for other communications (not shown), for example, data communications and/or control signaling with the UE 104 and/or other UE(s) (not shown).

### Example Operations of a User Equipment

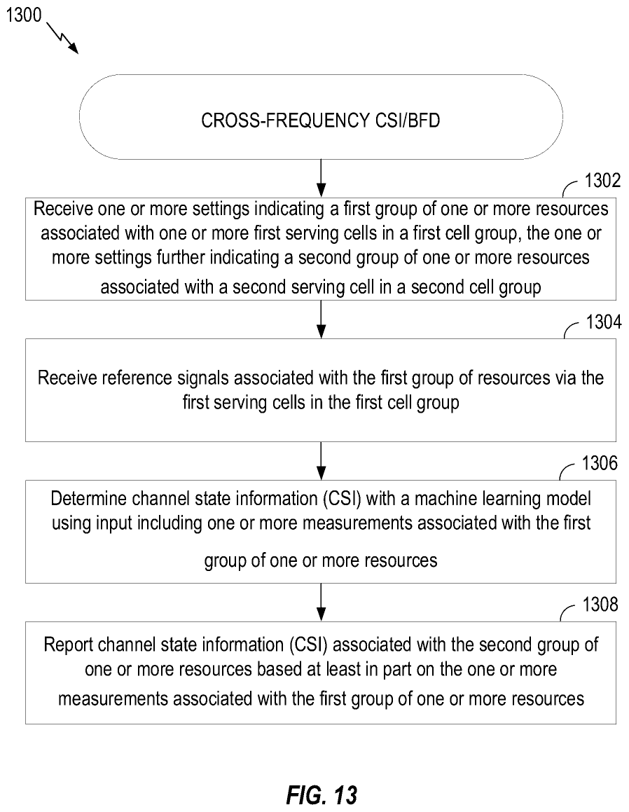

FIG. 13 shows a method 1300 for wireless communications by a UE, such as UE 104 of FIGS. 1 and 3.

The method 1300 may optionally begin at block 1302, where the UE may receive one or more settings (e.g., the setting(s) 614) indicating a first group of one or more resources (e.g., the CSI-RS resources 602-608) associated with one or more first serving cells (e.g., the serving cells 1202a, 1202b) in a first cell group (e.g., the first cell group 1220). The one or more settings may further indicate a second group of one or more resources (e.g., the SSBs 610) associated with a second serving cell (e.g., the serving cell 1202c) in a second cell group (e.g., the second cell group 1222). The UE may receive the settings via radio resource control (RRC) signaling, downlink control information (DCI), medium access control (MAC) signaling, and/or system information. The UE may receive the settings from any of the serving cells in the first cell group and/or the second cell group. The first group of resources and the second group of resources may be collectively referred to as cross-frequency resources.

At block 1304, the UE may receive reference signals (e.g., CSI-RS(s) and/or SSB(s)) associated with the first group of resources via the first serving cells in the first cell group. For example, the UE may be configured to periodically monitor for the reference signals via the first group of resources. In certain cases, the UE may be triggered to monitor for aperiodic reference signals associated with the first group of resources.

Optionally, at block 1306, the UE may determine CSI, associated with the second group of one or more resources, with a machine learning model (e.g., the machine learning models 724) using input including one or more measurements associated with the first group of one or more resources, for example, as described herein with respect to FIG. 7.

At block 1308, the UE may report the CSI associated with the second group of resources based at least in part on one or more measurements associated with the first group of one or more resources. For example, the UE may transmit the CSI to any of the serving cells in the first cell group and/or the second cell group. The UE may report the CSI associated with the second group of resources

The cross-frequency resources may include various resources associated with reference signals. For example, the first group of resources may include one or more CSI-RS resources, one or more CSI-IM resources, one or more SSB resources, or a combination thereof. The second group of resources may include one or more CSI-RS resources, one or more SSB resources, or a combination thereof.

The cross-frequency resources may be associated with sub-groups. The settings may indicate one or more first sub-groups among the first group of resources and/or one or more second sub-groups among the second group of resources. Each of the first sub-groups may be associated with a hypothesis for determining the CSI associated with the second group of resources, for example, as described herein with respect to FIG. 6. Each of the first sub-groups may be associated with a property associated with at least one resource of the second group of resources. For example, measurements associated with one of the first sub-groups may be used to determine certain properties associated with at least one of the resources of the second group of resources.

The resources for each of the sub-groups may be selected based on various criteria, for example, as described herein with respect to FIG. 6. The UE may identify one or more sub-groups among the first group of resources based on one or more criteria associated with the first group of one or more resources. The one or more criteria may include a TCI state, a serving cell identifier, a CSI resource setting identifier, a CSI resource set identifier, an indication of a sub-group, or a combination thereof, for example, as described herein with respect to FIG. 6. In some cases, each of the sub-groups may include only channel measurement (CM) resources. In certain cases, at least one of the sub-groups may include an interference measurement (IM) resource and a CM resource.

In certain cases, the UE may transmit, to a network entity (e.g., any of the serving cells in the first cell group and the second cell group), an indication of the one or more sub-groups. The indication of the sub-groups may include a single identifier (e.g., CRI or SSBRI) associated with a resource in each of the sub-groups. Each of the sub-groups may be indicated by a single identifier. In some cases, the indication of the sub-groups may include an identifier (e.g., CRI or SSBRI) associated with each resource in each of the more sub-groups.

Each of the second sub-groups may be associated with a different TRP of the second serving cell, for example, as described herein with respect to FIG. 10. The settings may indicate one or more second sub-groups among the second group of resources via a CSI resource setting, a CSI resource set, or a sub-group identifier. In some cases, the UE may select a portion of the second group of resources for reporting the CSI. For example, the UE may select at least at least one resource from each of the second sub-groups for reporting the CSI. The CSI may be associated with at least one resource from each of the second sub-groups. To report the CSI, the UE may report the CSI associated with the selected at least one resource from each of the second sub-groups. Each of the second sub-groups may be associated with a certain CORESET pool (e.g., the CORESET pools 1036, 1038) and/or a particular TRP. Each of the CORESET pools may have a corresponding CORSET pool identifier. A CORESET pool may be associated with a particular TRP.

The cross-frequency resources may be associated with various QCL assumptions (e.g., TCI states). In certain cases, the settings may indicate one or more TCI states associated with the first group of resources and/or the second group of resources, where each of the TCI states may indicate a particular QCL assumption associated with one or more resources in the first group of resources and/or the second group of resources.

The cross-frequency resources may be associated with multiple frequency ranges. The first cell group may be in a first frequency range, for example, including one or more bands in FR1, and the second cell group may be in a second frequency range, for example, including one or more bands in FR2. The first frequency range may be different from the second frequency range. In some cases, the first frequency range may be FR1, and the second frequency range may be FR2.

In certain aspects, the settings may indicate which properties associated with the second group of resources to report in the CSI, for example, as described herein with respect to FIG. 8. The report quantity may indicate which properties associated with the second group of resources to report in the CSI via properties associated with one or more sub-groups of the first group of resources and/or via properties associated with the second group of resources. The settings may indicate a report quantity (e.g., the report quantity field in FIG. 8) associated with the CSI. The report quantity may indicate one or more sets of one or more properties associated with the second group of resources to report via the CSI. In some cases, the report quantity may indicate each of one or more sub-groups (e.g., the sub-groups 618) associated with the first group of resources is associated with a set of one or more properties associated with the second group of one or more resources to report via the CSI. A set of properties may include SSBRI, CRI, L1-RSRP, L1-SINR, RI, CQI, PMI, or any combination thereof.

In certain aspects, the settings may indicate the cross-frequency resources via a CSI report setting, a CSI resource setting, and/or a CSI resource set, for example, as described herein with respect to FIGS. 8 and 9. The settings may include one or more first CSI resource settings (e.g., CSI-ResourceConfig #1) indicating the first group of resources, and the settings may include one or more second CSI resource settings (e.g., CSI-ResourceConfig #2) indicating the second group of resources. In certain aspects, the first CSI resource setting(s) may indicate the first group of resources in one or more CSI resource sets (e.g., CSI-ResourceSet #1a and CSI-ResourceSet #1b). In certain aspects, the settings may include a CSI report setting indicating the first CSI resource settings and the second CSI resource settings.

For certain aspects, the settings may indicate to which serving cell the UE will report the CSI. For example, the settings may include a CSI report setting indicating to report the CSI associated with the second group of one or more resources via the first serving cells and/or the second serving cell. In some cases, the CSI report setting may further indicate the serving cell used to report the CSI via a serving cell identifier, such as a serving cell index. The CSI report setting may further indicate each of the first serving cells via the serving cell identifier. The serving cell identifier(s) indicated in the CSI report setting may be indicative of the serving cell(s) to which the UE will report the CSI. In certain cases, the CSI reporting setting may indicate to report the CSI associated with the second group of one or more resources via the second serving cell, where the CSI report setting further indicates the second serving cell via a serving cell identifier. To report the CSI, the UE may report the reporting the CSI associated with the second group of one or more resources via the first serving cells and/or the second serving cell, for example, as indicated by the CSI report setting.

In certain aspects, the machine learning model may be used to determine the CSI via the measurements associated with certain sub-groups of the first group of resources. The input of the machine learning model may further include one or more PDPs associated with each of the one or more sub-groups, one or more AoAs associated with the one or more sub-groups, or a combination thereof. To determine the CSI, the UE may output, based on the machine learning model, one or more properties associated with at least one resource in the second group of one or more resources. The properties may include a SE, a RSRP (e.g., L1-RSRP), a SINR (e.g., L1-SINR), a RI, a CQI, or a PMI, or a combination thereof. In certain cases, the UE may determine the CSI with a plurality of machine learning models. Each of the machine learning models may be associated with a resource of the second group of resources or is configured with a set of one or more parameters associated with the resource of the second group of one or more resources. In some cases, each of the machine learning models may be associated with a sub-group of the sub-groups among the first group of resources or is configured with a set of one or more parameters associated with the sub-group. For example, the UE may use a sub-group specific or resource-specific machine learning model to determine the CSI associated with a particular resource of the second group of resources.

For certain aspects, federated learning may be used for the machine learning at the UE. The UE may determine one or more properties associated with each resource of the second group of one or more resources based on one or more measurements associated with the second group of one or more resources. The properties may include SSBRI, CRI, L1-RSRP, L1-SINR, RI, CQI, PMI, or any combination thereof. The UE may determine a reception spatial filter (e.g., the reception spatial filters 730) for the properties associated with each resource of the second group of resources based on at least one of the sub-groups that is associated with the respective resource of the second group of one or more resources. The UE may train one or more machine learning models with one or more measurements associated with the sub-groups and the determined properties associated with each resource of the second group of one or more resources as one or more ground-truth labels. The UE may determine the CSI with the trained one or more machine learning models. In some cases, the UE may receive an indication to train the machine learning models, and the UE may train the machine learning models in response to the indication. In certain cases, the UE may transmit, to a network entity (e.g., any of the serving cells in the first cell group and the second cell group), an indication of the trained machine learning models and/or information associated with the trained machine learning models. The network entity may use the information to update the machine learning models for the UE and/or other UEs.

In certain aspects, certain machine learning operations may be performed at the network, for example, training machine learning models for the UE and/or training machine learning models for various network-side functions. In some cases, the UE may report the CSI associated with the second group of resources based at least in part on one or more measurements associated with the second group of resources. For example, the CSI may be determined directly from measurements of the second group of resources, and the network may train certain machine learning models using the direct measurements of the second group of resources. In certain cases, the UE may transmit, to a network entity, an indication of the reception spatial filter for the properties associated with each resource of the second group of resources, where the reception spatial filters may be determined based on sub-groups among the first group of resources. In some cases, the UE may transmit, to the network entity, an indication of properties (e.g., PDPs and/or AoAs) associated with at least one of the sub-groups (e.g., a particular sub-group or each of the sub-groups) among the first group of resources. The UE may transmit the indication of the properties associated with each of the sub-groups.

In certain aspects, the second group of resources may include one or more virtual resources, as described herein with respect to FIG. 12B. The UE may not expect to receive certain communications (e.g., reference signal(s)) via the virtual resources from the second cell group. For example, the UE may refrain from monitoring for certain communications (e.g., reference signal(s)) via the virtual resources. The UE may refrain from receiving one or more signals (e.g., references signal(s)) via the virtual resources. In some cases, the UE may use the virtual resources for other communications (e.g., data communications and/or control signaling) with the second cell group and refrain from monitoring for certain communications (e.g., reference signal(s)) via the virtual resources.

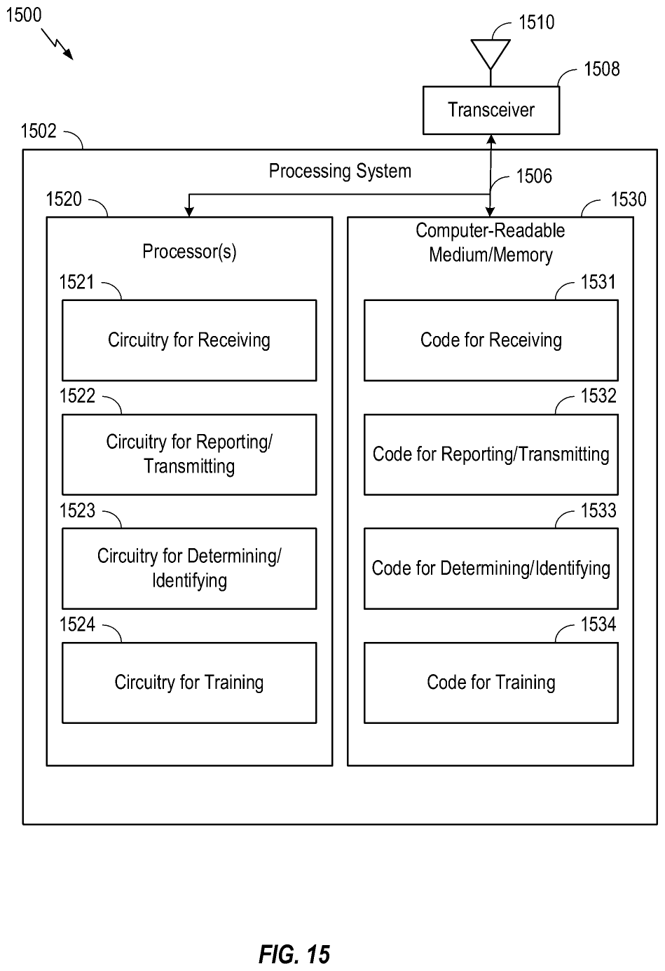

In certain aspects, the method 1300, or any aspect related to it, may be performed by an apparatus, such as communications device 1500 of FIG. 15, which includes various components operable, configured, or adapted to perform the method 1300. Apparatus 1500 is described below in further detail.

Note that FIG. 13 is just one example of a method, and other methods including fewer, additional, or alternative steps are possible consistent with this disclosure.

### Example Operations of a Network Entity

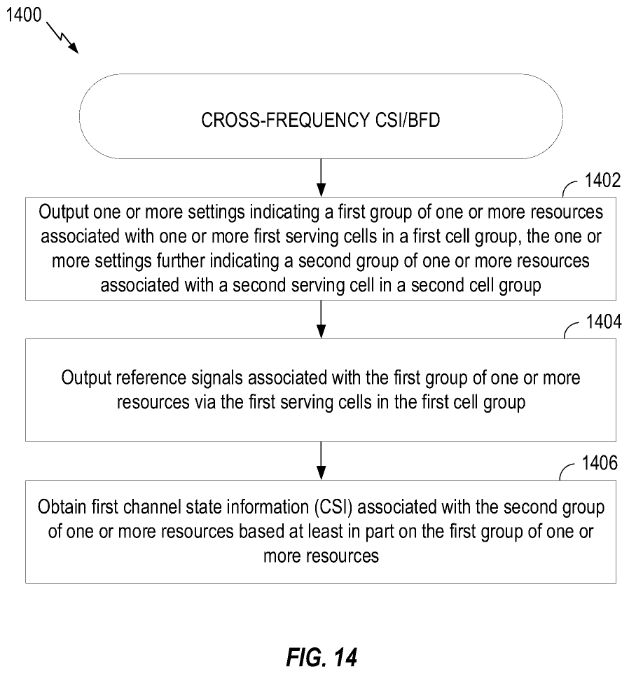

FIG. 14 shows a method 1400 for wireless communications by a network entity, such as BS 102 of FIGS. 1 and 3, or a disaggregated base station as discussed with respect to FIG. 2.

The method 1400 may optionally begin at block 1402, where the network entity may output (e.g., provide or transmit) one or more settings (e.g., the setting(s) 614) indicating a first group of one or more resources (e.g., the CSI-RS resources 602-608) associated with one or more first serving cells (e.g., the serving cells 1202a, 1202b) in a first cell group (e.g., the first cell group 1220). The settings may further indicate a second group of one or more resources (e.g., the SSBs 610) associated with a second serving cell (e.g., the serving cell 1202c) in a second cell group (e.g., the second cell group 1222). For example, the network entity may transmit the one or more settings to a UE (e.g., the UE 104).

Optionally, at block 1404, the network entity may output reference signals associated with the first group of resources via the first serving cells in the first cell group. For example, the network entity may output periodic, semi-persistent, or aperiodic reference signals. The reference signals may include CSI-RSs and/or SSBs, for example.

At block 1406, the network entity may obtain (e.g., receive) first CSI associated with the second group of one or more resources based at least in part on the first group of one or more resources.

The cross-frequency resources may include various resources associated with reference signals, for example, as described herein with respect to FIG. 13. For example, the first group of resources may include one or more CSI-RS resources, one or more CSI-IM resources, one or more SSB resources, or a combination thereof. The second group of resources may include one or more CSI-RS resources, one or more SSB resources, or a combination thereof.

The cross-frequency resources may be associated with sub-groups, for example, as described herein with respect to FIG. 13. The settings may indicate one or more first sub-groups among the first group of resources and/or one or more second sub-groups among the second group of resources. The network entity may output an indication of one or more criteria associated with the first group of resources used to select the first sub-groups. The network entity may obtain, from the UE, an indication of the first sub-groups among the first group of resources based on the one or more criteria. The one or more criteria may include a TCI state, a serving cell identifier, a CSI resource setting identifier, a CSI resource set identifier, an indication of a sub-group, or a combination thereof, for example, as described herein with respect to FIG. 6. In some cases, each of the sub-groups may include only channel measurement (CM) resources. In certain cases, at least one of the sub-groups may include an interference measurement (IM) resource and a CM resource. The indication of the sub-groups may include a single identifier (e.g., CRI or SSBRI) associated with a resource in each of the sub-groups. Each of the sub-groups may be indicated by a single identifier (e.g., CRI or SSBRI). In some cases, the indication of the sub-groups may include an identifier associated with each resource in each of the more sub-groups.

Each of the second sub-groups may be associated with a different TRP of the second serving cell, for example, as described herein with respect to FIG. 10. The settings may indicate one or more second sub-groups among the second group of resources via a CSI resource setting, a CSI resource set, or a sub-group identifier. The network entity may obtain the first CSI associated with at least one resource from each of the second sub-groups. Each of the second sub-groups may be associated with a CORESET pool identifier or a TRP.

The cross-frequency resources may be associated with multiple frequency ranges, for example, as described herein with respect to FIG. 13. The first cell group may be in a first frequency range, for example, including one or more bands in FR1, and the second cell group may be in a second frequency range, for example, including one or more bands in FR2.

In certain aspects, the settings may indicate which properties associated with the second group of resources to report in the CSI, for example, as described herein with respect to FIG. 8. The settings may indicate a report quantity associated with the first CSI. In some cases, the report quantity may indicate one or more sets of one or more properties associated with the second group of resources to report via the CSI. In certain cases, the report quantity may indicate each of one or more first sub-groups associated with the first group of resources is associated with a set of one or more properties associated with the second group of one or more resources to report via the first CSI. A set of properties may include SSBRI, CRI, L1-RSRP, L1-SINR, RI, CQI, PMI, or any combination thereof.

For certain aspects, the settings may indicate the cross-frequency resources via a CSI report setting, a CSI resource setting, and/or a CSI resource set, for example, as described herein with respect to FIGS. 8 and 9. The settings may include one or more first CSI resource settings (e.g., CSI-ResourceConfig #1) indicating the first group of resources, and the settings may include one or more second CSI resource settings (e.g., CSI-ResourceConfig #2) indicating the second group of resources. In certain aspects, the first CSI resource setting(s) may indicate the first group of resources in one or more CSI resource sets (e.g., CSI-ResourceSet #1a and CSI-ResourceSet #1b). In certain aspects, the settings may include a CSI report setting indicating the first CSI resource settings and the second CSI resource settings.

For certain aspects, the settings may indicate to which serving cell the UE will report the CSI. For example, the settings may include a CSI report setting indicating to report the CSI associated with the second group of one or more resources via the first serving cells and/or the second serving cell. In some cases, the CSI report setting may further indicate the serving cell used to report the CSI via a serving cell identifier, such as a serving cell index. The network entity may obtain the first CSI associated with the second group of one or more resources via the one or more first serving cells and/or via the second serving cell, for example, as indicated by the CSI report setting.

In certain aspects, federated learning may be used for machine learning operations at the UE. For example, the network entity may output an indication to train one or more machine learning models for generating the first CSI at the UE. The network entity may obtain an indication of (and/or information associated with) one or more trained machine learning models for generating the first CSI at the UE. The network entity may update the machine learning models based on the information, and the network entity may configure the UE and/or other UEs with the updated machine learning models.

In certain aspects, certain machine learning operations may be performed at the network entity, for example, training machine learning models for the UE and/or training machine learning models for various network-side functions. The network entity may obtain second CSI associated with the second group of resources based at least in part on the second group of resources. The second CSI may be determined directly from measurements of the second group of resources. The network entity may obtain an indication of the reception spatial filter for the properties associated with each resource of the second group of resources, where the reception spatial filters may be determined at the UE based on sub-groups among the first group of resources. The network entity may obtain an indication of properties (e.g., PDPs and/or AoAs) associated with at least one of the sub-groups (e.g., a particular sub-group or each of the sub-groups) among the first group of resources. The network entity may train a machine learning model based on the second CSI, reception spatial filters, and/or the properties associated with the sub-groups. The network entity may perform various functions using the trained machine learning model, such as beamforming, scheduling, and/or configuring the link between a UE and the network entity (e.g., adaptive modulation and coding). As an example, the network entity may schedule one or more transmission for the UE using the trained machine learning model.

In certain aspects, the second group of resources may include one or more virtual resources, as described herein with respect to FIG. 12B. The network entity may not expect to transmit or receive certain communications (e.g., reference signal(s)) via the virtual resources. For example, the network entity may refrain from transmitting for certain communications (e.g., reference signal(s)) via the virtual resources. The network entity may refrain from transmitting one or more signals (e.g., reference signal(s)) via the virtual resources. In some cases, the network entity may use the virtual resources for other communications (e.g., data communications and/or control signaling) with one or more UEs and refrain from transmitting certain communications (e.g., reference signal(s)) via the virtual resources.

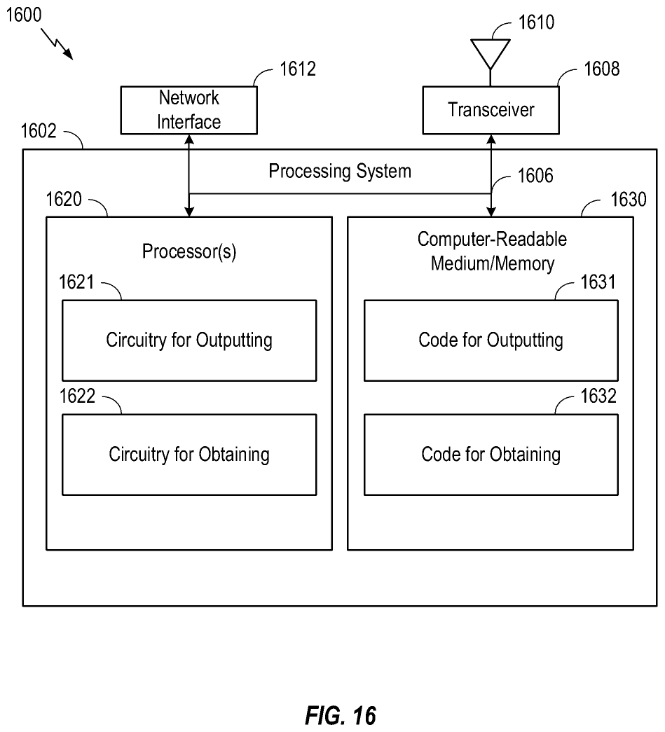

In one aspect, the method 1400, or any aspect related to it, may be performed by an apparatus, such as communications device 1600 of FIG. 16, which includes various components operable, configured, or adapted to perform the method 1400. Apparatus 1600 is described below in further detail.

Note that FIG. 14 is just one example of a method, and other methods including fewer, additional, or alternative steps are possible consistent with this disclosure.

While the examples provided herein are described with respect to cross-frequency CSI/BFD being determined in terms of FR1 and FR2 to facilitate understanding, aspects of the present disclosure may also be applied to cross-frequency CSI/BFD being determined in terms of other frequency ranges, such as FR1 and FR3, FR1 and FR4, FR1 and FR4a, FR1 and FR5, FR3 and FR2, FR2 and FR4, or any other combination of frequency ranges. For example, the UE may determine FR3 CSI based on measurements associated with FR1 resources. In some cases, the UE may determine FR4 CSI based on measurements associated with FR1 resources.

While the examples provided herein are described with respect to cross-frequency CSI/BFD being determined using machine learning to facilitate understanding, aspects of the present disclosure may also be applied to determining cross-frequency CSI/BFD using other aspects of artificial intelligence, such as deep learning and/or a neural networks.

### Example Communications Devices

FIG. 15 depicts aspects of an example communications device 1500. In some aspects, communications device 1500 is a user equipment, such as UE 104 described above with respect to FIGS. 1 and 3.

The communications device 1500 includes a processing system 1502 coupled to a transceiver 1508 (e.g., a transmitter and/or a receiver). The transceiver 1508 is configured to transmit and receive signals for the communications device 1500 via an antenna 1510, such as the various signals as described herein. The processing system 1502 may be configured to perform processing functions for the communications device 1500, including processing signals received and/or to be transmitted by the communications device 1500.

The processing system 1502 includes one or more processors 1520. In various aspects, the one or more processors 1520 may be representative of one or more of receive processor 358, transmit processor 364, TX MIMO processor 366, and/or controller/processor 380, as described with respect to FIG. 3. The one or more processors 1520 are coupled to a computer-readable medium/memory 1530 via a bus 1506. In certain aspects, the computer-readable medium/memory 1530 is configured to store instructions (e.g., computer-executable code) that when executed by the one or more processors 1520, cause the one or more processors 1520 to perform the method 1300 described with respect to FIG. 13, or any aspect related to it. Note that reference to a processor performing a function of communications device 1500 may include one or more processors performing that function of communications device 1500.

In the depicted example, computer-readable medium/memory 1530 stores code (e.g., executable instructions) for receiving 1531, code for reporting/transmitting 1532, code for determining/identifying 1533, code for training 1534, or any combination thereof. Processing of the code 1531-1532 may cause the communications device 1500 to perform the method 1300 described with respect to FIG. 13, or any aspect related to it.

The one or more processors 1520 include circuitry configured to implement (e.g., execute) the code stored in the computer-readable medium/memory 1530, including circuitry for receiving 1521, circuitry for reporting/transmitting 1522, circuitry for determining/identifying 1523, circuitry for training 1524, or any combination thereof. Processing with circuitry 1521-1524 may cause the communications device 1500 to perform the method 1300 described with respect to FIG. 13, or any aspect related to it.

Various components of the communications device 1500 may provide means for performing the method 1300 described with respect to FIG. 13, or any aspect related to it. For example, means for transmitting, sending or outputting for transmission may include the transceivers 354 and/or antenna(s) 352 of the UE 104 illustrated in FIG. 3 and/or transceiver 1508 and antenna 1510 of the communications device 1500 in FIG. 15. Means for receiving or obtaining may include the transceivers 354 and/or antenna(s) 352 of the UE 104 illustrated in FIG. 3 and/or transceiver 1508 and antenna 1510 of the communications device 1500 in FIG. 14.

FIG. 16 depicts aspects of an example communications device. The communications device 1600 includes a processing system 1602 coupled to a transceiver 1608 (e.g., a transmitter and/or a receiver) and/or a network interface 1612. The transceiver 1608 is configured to transmit and receive signals for the communications device 1600 via an antenna 1610, such as the various signals as described herein. The network interface 1612 is configured to obtain and send signals for the communications device 1600 via communications link(s), such as a backhaul link, midhaul link, and/or fronthaul link as described herein, such as with respect to FIG. 2. The processing system 1602 may be configured to perform processing functions for the communications device 1600, including processing signals received and/or to be transmitted by the communications device 1600.

The processing system 1602 includes one or more processors 1620. In various aspects, one or more processors 1620 may be representative of one or more of receive processor 338, transmit processor 320, TX MIMO processor 330, and/or controller/processor 340, as described with respect to FIG. 3. The one or more processors 1620 are coupled to a computer-readable medium/memory 1630 via a bus 1606. In certain aspects, the computer-readable medium/memory 1630 is configured to store instructions (e.g., computer-executable code) that when executed by the one or more processors 1620, cause the one or more processors 1620 to perform the method 1400 described with respect to FIG. 14, or any aspect related to it. Note that reference to a processor of communications device 1600 performing a function may include one or more processors of communications device 1600 performing that function.

In the depicted example, the computer-readable medium/memory 1630 stores code (e.g., executable instructions) for outputting 1631 and code for obtaining 1632. Processing of the code 1632, 1632 may cause the communications device 1600 to perform the method 1400 described with respect to FIG. 14, or any aspect related to it.

The one or more processors 1620 include circuitry configured to implement (e.g., execute) the code stored in the computer-readable medium/memory 1630, including circuitry for outputting 1621 and circuitry for obtaining 1622. Processing with circuitry 1621, 1622 may cause the communications device 1600 to perform the method 1400 as described with respect to FIG. 14, or any aspect related to it.

Various components of the communications device 1600 may provide means for performing the method 1400 as described with respect to FIG. 14, or any aspect related to it. Means for transmitting, sending or outputting for transmission may include the transceivers 332 and/or antenna(s) 334 of the BS 102 illustrated in FIG. 3 and/or transceiver 1608 and antenna 1610 of the communications device 1600 in FIG. 16. Means for receiving or obtaining may include the transceivers 332 and/or antenna(s) 334 of the BS 102 illustrated in FIG. 3 and/or transceiver 1608 and antenna 1610 of the communications device 1600 in FIG. 16.

### Example Clauses

Implementation examples are described in the following numbered clauses:

Aspect 1: An apparatus for wireless communication, comprising: a memory; and a processor coupled to the memory, the processor being configured to: receive one or more settings indicating a first group of one or more resources associated with one or more first serving cells in a first cell group, the one or more settings further indicating a second group of one or more resources associated with a second serving cell in a second cell group; and report channel state information (CSI) associated with the second group of one or more resources based at least in part on one or more measurements associated with the first group of one or more resources.

Aspect 2: The apparatus of Aspect 1, wherein: the first group of one or more resources includes: one or more CSI reference signal (CSI-RS) resources, one or more CSI interference measurement (CSI-IM) resources, one or more synchronization signal block (SSB) resources, or a combination thereof; and the second group of one or more resources includes: one or more CSI-RS resources, one or more SSB resources, or a combination thereof.

Aspect 3: The apparatus of Aspect 1 or 2, wherein the one or more settings indicate one or more sub-groups among the first group of one or more resources, and wherein the one or more settings indicate one or more transmission configuration indicator (TCI) states associated with the first group of one or more resources.

Aspect 4: The apparatus according to any of Aspects 1-3, further comprising a transceiver configured to receive the one or more settings and report the CSI, wherein the first cell group is in a first frequency range including one or more bands in frequency range 1 (FR1), and the second cell group is in a second frequency range including one or more bands in frequency range 2 (FR2).

Aspect 5: The apparatus according to any of Aspects 1-4, wherein the one or more settings indicate a report quantity associated with the CSI, wherein the report quantity indicates one or more sets of one or more properties associated with the second group of resources to report via the CSI.

Aspect 6: The apparatus according to any of Aspects 1-5, wherein the one or more settings indicate a report quantity associated with the CSI, wherein the report quantity indicates each of one or more sub-groups associated with the first group of one or more resources is associated with a set of one or more properties associated with the second group of one or more resources to report via the CSI.

Aspect 7: The apparatus according to any of Aspects 1-6, wherein the one or more settings include: one or more first CSI resource settings indicating the first group of one or more resources; and one or more second CSI resource settings indicating the second group of one or more resources.

Aspect 8: The apparatus of Aspect 7, wherein the one or more first CSI resource settings indicate the first group of one or more resources in one or more CSI resource sets.

Aspect 9: The apparatus according to any of Aspects 1-8, wherein the processor is further configured to: identify one or more sub-groups among the first group of one or more resources based on one or more criteria associated with the first group of one or more resources; and transmit, to a network entity, an indication of the one or more sub-groups.

Aspect 10: The apparatus according to any of Aspects 1-9, wherein the processor is further configured to: identify one or more sub-groups among the first group of one or more resources, wherein each of the one or more sub-groups is associated with a property associated with at least one resource of the second group of one or more resources; determine one or more properties associated with each resource of the second group of one or more resources based on one or more measurements associated with the second group of one or more resources; determine a reception spatial filter for the one or more properties associated with each resource of the second group of one or more resources based on at least one of the one or more sub-groups that is associated with the respective resource of the second group of one or more resources; train one or more machine learning models with one or more measurements associated with the one or more sub-groups and the determined one or more properties associated with each resource of the second group of one or more resources as one or more ground-truth labels; and determine the CSI with the trained one or more machine learning models.

Aspect 11: The apparatus according to any of Aspects 1-10, wherein the processor is further configured to: report the CSI associated with the second group of one or more resources based at least in part on one or more measurements associated with the second group of one or more resources.

Aspect 12: The apparatus according to any of Aspects 1-11, wherein the one or more settings indicate one or more sub-groups among the second group of one or more resources via a CSI resource setting, a CSI resource set, or a sub-group identifier.

Aspect 13: The apparatus of Aspect 12, wherein each of the one or more sub-groups is associated with a control resource set (CORESET) pool identifier or a transmission-reception point (TRP).

Aspect 14: An apparatus for wireless communication, comprising: a memory; and a processor coupled to the memory, the processor being configured to: output one or more settings indicating a first group of one or more resources associated with one or more first serving cells in a first cell group, the one or more settings further indicating a second group of one or more resources associated with a second serving cell in a second cell group; and obtain first channel state information (CSI) associated with the second group of one or more resources based at least in part on the first group of one or more resources.

Aspect 15: The apparatus of Aspect 14, wherein: the first group of one or more resources includes: one or more CSI reference signal (CSI-RS) resources, one or more CSI interference measurement (CSI-IM) resources, one or more synchronization signal block (SSB) resources, or a combination thereof; and the second group of one or more resources includes: one or more CSI-RS resources, one or more SSB resources, or a combination thereof.

Aspect 16: The apparatus of Aspect 14 or 15, wherein the one or more settings indicate one or more sub-groups among the first group of one or more resources, and wherein the one or more settings indicate one or more transmission configuration indicator (TCI) states associated with the first group of one or more resources.

Aspect 17: The apparatus according to any of Aspects 14-16, further comprising a transceiver configured to output the one or more settings and obtain the first CSI, wherein the first cell group is in a first frequency range including one or more bands in frequency range 1 (FR1), and the second cell group is in a second frequency range including one or more bands in frequency range 2 (FR2).

Aspect 18: The apparatus according to any of Aspects 14-17, wherein the one or more settings indicate a report quantity associated with the first CSI, wherein the report quantity indicates one or more sets of one or more properties associated with the second group of resources to report via the CSI.

Aspect 19: The apparatus according to any of Aspects 14-18, wherein the one or more settings indicate a report quantity associated with the first CSI, wherein the report quantity indicates each of one or more sub-groups associated with the first group of one or more resources is associated with a set of one or more properties associated with the second group of one or more resources to report via the first CSI.

Aspect 20: The apparatus according to any of Aspects 14-19, wherein the one or more settings include: one or more first CSI resource settings indicating the first group of one or more resources; and one or more second CSI resource settings indicating the second group of one or more resources.

Aspect 21: The apparatus of Aspect 20, wherein the one or more first CSI resource settings indicate the first group of one or more resources in one or more CSI resource sets.

Aspect 22: The apparatus according to any of Aspects 14-21, wherein the processor is further configured to: obtain an indication of one or more sub-groups among the first group of one or more resources based on one or more criteria associated with the first group of one or more resources.

Aspect 23: The apparatus of Aspect 14, wherein the processor is further configured to: output an indication to train one or more machine learning models for generating the first CSI at a user equipment.

Aspect 24: The apparatus according to any of Aspects 14-23, wherein the processor is further configured to: obtain an indication of one or more trained machine learning models for generating the first CSI at a user equipment.

Aspect 25: The apparatus according to any of Aspects 14-24, wherein the processor is further configured to: obtain second CSI associated with the second group of one or more resources based at least in part on the second group of one or more resources; train a machine learning model based on the second CSI; and schedule one or more transmissions for a user equipment using the trained machine learning model.

Aspect 26: The apparatus according to any of Aspects 14-26, wherein the one or more settings indicate one or more sub-groups among the second group of one or more resources via a CSI resource setting, a CSI resource set, or a sub-group identifier.

Aspect 27: The apparatus of Aspect 26, wherein each of the one or more sub-groups is associated with a control resource set (CORESET) pool identifier or a transmission-reception point (TRP).

Aspect 28: A method of wireless communication by a user equipment, comprising: receiving one or more settings indicating a first group of one or more resources associated with one or more first serving cells in a first cell group, the one or more settings further indicating a second group of one or more resources associated with a second serving cell in a second cell group; and reporting channel state information (CSI) associated with the second group of one or more resources based at least in part on one or more measurements associated with the first group of one or more resources.

Aspect 29: The method of Aspect 28, wherein: the first group of one or more resources includes: one or more CSI reference signal (CSI-RS) resources, one or more CSI interference measurement (CSI-IM) resources, one or more synchronization signal block (SSB) resources, or a combination thereof; and the second group of one or more resources includes: one or more CSI-RS resources, one or more SSB resources, or a combination thereof.

Aspect 30: The method of Aspect 28 or 29, wherein the one or more settings indicate one or more sub-groups among the first group of one or more resources, and wherein the one or more settings indicate one or more transmission configuration indicator (TCI) states associated with the first group of one or more resources.

Aspect 31: The method according to any of Aspects 28-30, wherein the first cell group is in a first frequency range including one or more bands in frequency range 1 (FR1), and the second cell group is in a second frequency range including one or more bands in frequency range 2 (FR2).

Aspect 32: The method according to any of Aspects 28-31, wherein the one or more settings indicate a report quantity associated with the CSI, wherein the report quantity indicates one or more sets of one or more properties associated with the second group of resources to report via the CSI.

Aspect 33: The method according to any of Aspects 28-32, wherein the one or more settings indicate a report quantity associated with the CSI, wherein the report quantity indicates each of one or more sub-group associated with the first group of one or more resources is associated with a set of one or more properties associated with the second group of one or more resources to report via the CSI.

Aspect 34: The method according to any of Aspects 28-33, wherein the one or more settings include: one or more first CSI resource settings indicating the first group of one or more resources; and one or more second CSI resource settings indicating the second group of one or more resources.

Aspect 35: The method of Aspect 34, wherein the one or more first CSI resource settings indicate the first group of one or more resources in one or more CSI resource sets.

Aspect 36: The method according to any of Aspects 28-35, wherein: the one or more settings include a CSI report setting indicating one or more first CSI resource settings and one or more second CSI resource settings, wherein the one more first CSI resource settings indicate the first group of one or more resources, and the one or more second CSI resource settings indicate the second group of one or more resources; the CSI report setting further indicates to report the CSI associated with the second group of one or more resources via the one or more first serving cells; the CSI report setting further indicates each of the one or more first serving cells via a serving cell identifier; and reporting the CSI associated with the second group of one or more resources comprises reporting the CSI associated with the second group of one or more resources via the one or more first serving cells.

Aspect 37: The method according to any of Aspects 28-36, wherein: the one or more settings include a CSI report setting indicating one or more first CSI resource settings and one or more second CSI resource settings, wherein the one more first CSI resource settings indicate the first group of one or more resources, and the one or more second CSI resource settings indicate the second group of one or more resources; the CSI report setting further indicates to report the CSI associated with the second group of one or more resources via the second serving cell; the CSI report setting further indicates the second serving cell via a serving cell identifier; and reporting the CSI associated with the second group of one or more resources comprises reporting the CSI associated with the second group of one or more resources via the second serving cell.

Aspect 38: The method according to any of Aspects 28-37, further comprising determining the CSI with a machine learning model using input including the one or more measurements associated with the first group of one or more resources.

Aspect 39: The method of Aspect 38, further comprising: identifying one or more sub-groups among the first group of one or more resources, wherein each of the one or more sub-groups is associated with a property associated with at least one resource of the second group of one or more resources; and wherein the input further includes one or more power delay profiles associated with each of the one or more sub-groups, one or more angles-of-arrival associated with the one or more sub-groups, or a combination thereof.

Aspect 40: The method of Aspect 38 or 39, wherein determining the CSI comprises: outputting, based on the machine learning model, one or more properties associated with at least one resource in the second group of one or more resources.

Aspect 41: The method of Aspect 40, wherein the one or more properties include a spectral efficiency (SE), a reference signal received power (RSRP), a signal-to-interference plus noise ratio (SINR), a rank indicator (RI), a channel quality indicator (CQI), or a precoding matrix indicator (PMI), or a combination thereof.

Aspect 42: The method according to any of Aspects 28-41, further comprising determining the CSI with a plurality of machine learning models, wherein each of the machine learning models is associated with a resource of the second group of one or more resources or is configured with a set of one or more parameters associated with the resource of the second group of one or more resources.

Aspect 43: The method according to any of Aspects 28-42, further comprising: identifying one or more sub-groups among the first group of one or more resources, wherein each of the one or more sub-groups is associated with a property associated with at least one resource of the second group of one or more resources; and determining the CSI with a plurality of machine learning models, wherein each of the machine learning models is associated with a sub-group of the one or more sub-groups or is configured with a set of one or more parameters associated with the sub-group.

Aspect 44: The method according to any of Aspects 28-43, further comprising: identifying one or more sub-groups among the first group of one or more resources based on one or more criteria associated with the first group of one or more resources; and transmitting, to a network entity, an indication of the one or more sub-groups.

Aspect 45: The method of Aspect 44, wherein the one or more criteria include: a TCI state; a serving cell identifier; a CSI resource setting identifier; a CSI resource set identifier; an indication of a sub-group; or a combination thereof.

Aspect 46: The method of Aspect 44 or 45, wherein the indication of the one or more sub-groups comprises a single identifier associated with a resource in each of the one or more sub-groups.

Aspect 47: The method according to any of Aspects 44-46, wherein the indication of the one or more sub-groups comprises an identifier associated with each resource in each of the one or more sub-groups.

Aspect 48: The method according to any of Aspects 28-47, further comprising: identifying one or more sub-groups among the first group of one or more resources, wherein each of the one or more sub-groups includes only channel measurement (CM) resources.

Aspect 49: The method according to any of Aspects 28-48, further comprising: identifying one or more sub-groups among the first group of one or more resources, wherein at least one of the one or more sub-groups includes an interference measurement (IM) resource and a CM resource.

Aspect 50: The method according to any of Aspects 28-49, further comprising: identifying one or more sub-groups among the first group of one or more resources, wherein each of the one or more sub-groups is associated with a property associated with at least one resource of the second group of one or more resources; determining one or more properties associated with each resource of the second group of one or more resources based on one or more measurements associated with the second group of one or more resources; determining a reception spatial filter for the one or more properties associated with each resource of the second group of one or more resources based on at least one of the one or more sub-groups that is associated with the respective resource of the second group of one or more resources; training one or more machine learning models with one or more measurements associated with the one or more sub-groups and the determined one or more properties associated with each resource of the second group of one or more resources as one or more ground-truth labels; and determining the CSI with the trained one or more machine learning models.

Aspect 51: The method of Aspect 50, further comprising: receiving an indication to train the one or more machine learning models for generating the CSI; and wherein training the one or more machine learning models comprises training the one or more machine learning models in response to the indication.

Aspect 52: The method of Aspect 50 or 51, further comprising: transmitting, to a network entity, an indication of the one or more trained machine learning models.

Aspect 53: The method according to any of Aspects 28-52, further comprising: reporting the CSI associated with the second group of one or more resources based at least in part on one or more measurements associated with the second group of one or more resources.

Aspect 54: The method according to any of Aspects 28-53, further comprising: identifying one or more sub-groups among the first group of one or more resources, wherein each of the one or more sub-groups is associated with a property associated with at least one resource of the second group of one or more resources; determining a reception spatial filter for one or more properties associated with the second group of one or more resources based on at least one of the one or more sub-groups that is associated with a respective resource of the second group of one or more resources; and transmitting, to a network entity, an indication of the reception spatial filter for the one or more properties associated with each resource of the second group of one or more resources.

Aspect 55: The method according to any of Aspects 28-54, further comprising: identifying one or more sub-groups among the first group of one or more resources, wherein each of the one or more sub-groups is associated with a property associated with at least one resource of the second group of one or more resources; and transmitting, to a network entity, an indication of one or more properties associated with at least one of the one or more sub-groups.

Aspect 56: The method of Aspect 55, wherein transmitting the indication of the one or more properties comprises transmitting the indication of the one or more properties associated with each of the one or more sub-groups.

Aspect 57: The method according to any of Aspects 28-56, wherein the one or more settings indicate one or more sub-groups among the second group of one or more resources via a CSI resource setting, a CSI resource set, or a sub-group identifier.

Aspect 58: The method of Aspect 57, further comprising: selecting at least one resource from each of the one or more sub-groups for reporting the CSI; and wherein the reporting the CSI comprises reporting the CSI associated with the selected at least one resource from each of the one or more sub-groups.

Aspect 59: The method of Aspect 57 or 58, wherein each of the one or more sub-groups is associated with a control resource set (CORESET) pool identifier or a transmission-reception point (TRP).

Aspect 60: A method of wireless communication by a network entity, comprising: outputting one or more settings indicating a first group of one or more resources associated with one or more first serving cells in a first cell group, the one or more settings further indicating a second group of one or more resources associated with a second serving cell in a second cell group; and obtaining first channel state information (CSI) associated with the second group of one or more resources based at least in part on the first group of one or more resources.

Aspect 61: The method of Aspect 60, wherein: the first group of one or more resources includes: one or more CSI reference signal (CSI-RS) resources, one or more CSI interference measurement (CSI-IM) resources, one or more synchronization signal block (SSB) resources, or a combination thereof; and the second group of one or more resources includes: one or more CSI-RS resources, one or more SSB resources, or a combination thereof.

Aspect 62: The method of Aspect 60 or 61, wherein the one or more settings indicate one or more sub-groups among the first group of one or more resources, and wherein the one or more settings indicate one or more transmission configuration indicator (TCI) states associated with the first group of one or more resources.

Aspect 63: The method according to any of Aspects 60-62, wherein the first cell group is in a first frequency range including one or more bands in frequency range 1 (FR1), and the second cell group is in a second frequency range including one or more bands in frequency range 2 (FR2).

Aspect 64: The method according to any of Aspects 60-63, wherein the one or more settings indicate a report quantity associated with the first CSI, wherein the report quantity indicates one or more sets of one or more properties associated with the second group of resources to report via the CSI.

Aspect 65: The method according to any of Aspects 60-64, wherein the one or more settings indicate a report quantity associated with the first CSI, wherein the report quantity indicates each of one or more sub-groups associated with the first group of one or more resources is associated with a set of one or more properties associated with the second group of one or more resources to report via the first CSI.

Aspect 66: The method according to any of Aspects 60-65, wherein the one or more settings include: one or more first CSI resource settings indicating the first group of one or more resources; and one or more second CSI resource settings indicating the second group of one or more resources.

Aspect 67: The method of Aspect 66, wherein the one or more first CSI resource settings indicate the first group of one or more resources in one or more CSI resource sets.

Aspect 68: The method according to any of Aspects 60-67, wherein: the one or more settings include a CSI report setting indicating one or more first CSI resource settings and one or more second CSI resource settings, wherein the one more first CSI resource settings indicate the first group of one or more resources, and the one or more second CSI resource settings indicate the second group of one or more resources; the CSI report setting further indicates to report the CSI associated with the second group of one or more resources via the one or more first serving cells; the CSI report setting further indicates each of the one or more first serving cells via a serving cell identifier; and obtaining the first CSI associated with the second group of one or more resources comprises obtaining the first CSI associated with the second group of one or more resources via the one or more first serving cells.

Aspect 69: The method according to any of Aspects 60-68, wherein: the one or more settings include a CSI report setting indicating one or more first CSI resource settings and one or more second CSI resource settings, wherein the one more first CSI resource settings indicate the first group of one or more resources, and the one or more second CSI resource settings indicate the second group of one or more resources; the CSI report setting further indicates to report the CSI associated with the second group of one or more resources via the second serving cell; the CSI report setting further indicates the second serving cell via a serving cell identifier; and obtaining the first CSI associated with the second group of one or more resources comprises obtaining the first CSI associated with the second group of one or more resources via the second serving cell.

Aspect 70: The method according to any of Aspects 60-69, further comprising: obtaining an indication of one or more sub-groups among the first group of one or more resources based on one or more criteria associated with the first group of one or more resources.

Aspect 71: The method of Aspect 70, wherein the one or more criteria include: a TCI state; a serving cell identifier; a CSI resource setting identifier; a CSI resource set identifier; an indication of a sub-group; or a combination thereof.

Aspect 72: The method of Aspect 70 or 71, wherein the indication of the one or more sub-groups comprises a single identifier associated with a resource in each of the one or more sub-groups.

Aspect 73: The method according to any of Aspects 70-72, wherein the indication of the one or more sub-groups comprises an identifier associated with each resource in each of the one or more sub-groups.

Aspect 74: The method according to any of Aspects 70-73, wherein each of the one or more sub-groups includes only channel measurement (CM) resources.

Aspect 75: The method according to any of Aspects 70-74, wherein at least one of the one or more sub-groups includes an interference measurement (IM) resource and a CM resource.

Aspect 76: The method according to any of Aspects 60-75, further comprising: outputting an indication to train one or more machine learning models for generating the first CSI at a user equipment.

Aspect 77: The method according to any of Aspects 60-76, further comprising: obtaining an indication of one or more trained machine learning models for generating the first CSI at a user equipment.

Aspect 78: The method according to any of Aspects 60-77, further comprising: obtaining second CSI associated with the second group of one or more resources based at least in part on the second group of one or more resources; training a machine learning model based on the second CSI; and scheduling one or more transmissions for a user equipment using the trained machine learning model.

Aspect 79: The method according to any of Aspects 60-78, further comprising: obtaining an indication of a reception spatial filter for one or more properties associated with each resource of the second group of one or more resources.

Aspect 80: The method according to any of Aspects 60-79, further comprising: obtaining an indication of one or more properties associated with at least one of one or more sub-groups among the first group of one or more resources.

Aspect 81: The method of Aspect 80, wherein obtaining the indication of the one or more properties comprises obtaining the indication of the one or more properties associated with each of one or more sub-groups among the first group of one or more resources.

Aspect 82: The method according to any of Aspects 60-81, wherein the one or more settings indicate one or more sub-groups among the second group of one or more resources via a CSI resource setting, a CSI resource set, or a sub-group identifier.

Aspect 83: The method of Aspect 82, further comprising: wherein the obtaining the first CSI comprises obtaining the first CSI associated with at least one resource from each of the one or more sub-groups.

Aspect 84: The method of Aspect 82 or 83, wherein each of the one or more sub-groups is associated with a control resource set (CORESET) pool identifier or a transmission-reception point (TRP).

Aspect 85: An apparatus, comprising: a memory; and a processor coupled to the memory, the processor being configured to perform a method in accordance with any of Aspects 28-84, 92, or 93.

Aspect 86: An apparatus, comprising means for performing a method in accordance with any of Aspects 28-84, 92, or 93.

Aspect 87: A non-transitory computer-readable medium comprising computer-executable instructions that, when executed by one or more processors of a processing system, cause the processing system to perform a method in accordance with any of Aspects 28-84, 92, or 93.

Aspect 88: A computer program product embodied on a computer-readable storage medium comprising code for performing a method in accordance with any of Aspects 28-84, 92, or 93.

Aspect 89: The apparatus according to any of Aspects 1-13, wherein the second group of one or more resources includes one or more virtual resources, the processor being further configured to refrain from receiving one or more signals via the one or more virtual resources.

Aspect 90: The apparatus according to any of Aspects 14-27, wherein the second group of one or more resources includes one or more virtual resources, the processor being further configured to refrain from transmitting one or more signals via the one or more virtual resources.

Aspect 92: The method according to any of Aspects 28-59, wherein the second group of one or more resources includes one or more virtual resources, the method further comprising refraining from receiving one or more signals via the one or more virtual resources.

Aspect 93: The method according to any of Aspects 60-84, wherein the second group of one or more resources includes one or more virtual resources, the method further comprising refraining from transmitting one or more signals via the one or more virtual resources.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, comprising:
a memory; and
a processor coupled to the memory, the processor being configured to:
receive one or more settings indicating a first group of one or more resources associated with one or more first serving cells in a first cell group, the one or more settings further indicating a second group of one or more resources associated with a second serving cell in a second cell group; and
report channel state information (CSI) associated with the second group of one or more resources based at least in part on one or more measurements associated with the first group of one or more resources.

2. The apparatus of claim 1, wherein:
the first group of one or more resources includes:
one or more CSI reference signal (CSI-RS) resources,
one or more CSI interference measurement (CSI-IM) resources,
one or more synchronization signal block (SSB) resources, or
a combination thereof; and
the second group of one or more resources includes:
one or more CSI-RS resources,
one or more SSB resources, or
a combination thereof.

3. The apparatus of claim 1, wherein the one or more settings indicate one or more sub-groups among the first group of one or more resources, and wherein the one or more settings indicate one or more transmission configuration indicator (TCI) states associated with the first group of one or more resources.

4. The apparatus of claim 1, further comprising a transceiver configured to receive the one or more settings and report the CSI, wherein the first cell group is in a first frequency range including one or more bands in frequency range 1 (FR1), and the second cell group is in a second frequency range including one or more bands in frequency range 2 (FR2).

5. The apparatus of claim 1, wherein the one or more settings indicate a report quantity associated with the CSI, wherein the report quantity indicates one or more sets of one or more properties associated with the second group of resources to report via the CSI.

6. The apparatus of claim 1, wherein the one or more settings indicate a report quantity associated with the CSI, wherein the report quantity indicates each of one or more sub-groups associated with the first group of one or more resources is associated with a set of one or more properties associated with the second group of one or more resources to report via the CSI.

7. The apparatus of claim 1, wherein the one or more settings include:
one or more first CSI resource settings indicating the first group of one or more resources; and
one or more second CSI resource settings indicating the second group of one or more resources.

8. The apparatus of claim 7, wherein the one or more first CSI resource settings indicate the first group of one or more resources in one or more CSI resource sets.

9. The apparatus of claim 1, wherein the processor is further configured to:
identify one or more sub-groups among the first group of one or more resources based on one or more criteria associated with the first group of one or more resources; and
transmit, to a network entity, an indication of the one or more sub-groups.

10. The apparatus of claim 1, wherein the processor is further configured to:
identify one or more sub-groups among the first group of one or more resources, wherein each of the one or more sub-groups is associated with a property associated with at least one resource of the second group of one or more resources;
determine one or more properties associated with each resource of the second group of one or more resources based on one or more measurements associated with the second group of one or more resources;
determine a reception spatial filter for the one or more properties associated with each resource of the second group of one or more resources based on at least one of the one or more sub-groups that is associated with the respective resource of the second group of one or more resources;
train one or more machine learning models with one or more measurements associated with the one or more sub-groups and the determined one or more properties associated with each resource of the second group of one or more resources as one or more ground-truth labels; and
determine the CSI with the trained one or more machine learning models.

11. The apparatus of claim 1, wherein the processor is further configured to:
report the CSI associated with the second group of one or more resources based at least in part on one or more measurements associated with the second group of one or more resources.

12. The apparatus of claim 1, wherein the one or more settings indicate one or more sub-groups among the second group of one or more resources via a CSI resource setting, a CSI resource set, or a sub-group identifier.

13. The apparatus of claim 12, wherein each of the one or more sub-groups is associated with a control resource set (CORESET) pool identifier or a transmission-reception point (TRP).

14. An apparatus for wireless communication, comprising:
a memory; and
a processor coupled to the memory, the processor being configured to:
output one or more settings indicating a first group of one or more resources associated with one or more first serving cells in a first cell group, the one or more settings further indicating a second group of one or more resources associated with a second serving cell in a second cell group; and
obtain first channel state information (CSI) associated with the second group of one or more resources based at least in part on the first group of one or more resources.

15. The apparatus of claim 14, wherein:
the first group of one or more resources includes:
one or more CSI reference signal (CSI-RS) resources,
one or more CSI interference measurement (CSI-IM) resources,
one or more synchronization signal block (SSB) resources, or
a combination thereof; and
the second group of one or more resources includes:
one or more CSI-RS resources,
one or more SSB resources, or
a combination thereof.

16. The apparatus of claim 14, wherein the one or more settings indicate one or more sub-groups among the first group of one or more resources, and wherein the one or more settings indicate one or more transmission configuration indicator (TCI) states associated with the first group of one or more resources.

17. The apparatus of claim 14, further comprising a transceiver configured to output the one or more settings and obtain the first CSI, wherein the first cell group is in a first frequency range including one or more bands in frequency range 1 (FR1), and the second cell group is in a second frequency range including one or more bands in frequency range 2 (FR2).

18. The apparatus of claim 14, wherein the one or more settings indicate a report quantity associated with the first CSI, wherein the report quantity indicates one or more sets of one or more properties associated with the second group of resources to report via the CSI.

19. The apparatus of claim 14, wherein the one or more settings indicate a report quantity associated with the first CSI, wherein the report quantity indicates each of one or more sub-groups associated with the first group of one or more resources is associated with a set of one or more properties associated with the second group of one or more resources to report via the first CSI.

20. The apparatus of claim 14, wherein the one or more settings include:
one or more first CSI resource settings indicating the first group of one or more resources; and
one or more second CSI resource settings indicating the second group of one or more resources.

21. The apparatus of claim 20, wherein the one or more first CSI resource settings indicate the first group of one or more resources in one or more CSI resource sets.

22. The apparatus of claim 14, wherein the processor is further configured to:
obtain an indication of one or more sub-groups among the first group of one or more resources based on one or more criteria associated with the first group of one or more resources.

23. The apparatus of claim 14, wherein the processor is further configured to:
output an indication to train one or more machine learning models for generating the first CSI at a user equipment.

24. The apparatus of claim 14, wherein the processor is further configured to:
obtain an indication of one or more trained machine learning models for generating the first CSI at a user equipment.

25. The apparatus of claim 14, wherein the processor is further configured to:
obtain second CSI associated with the second group of one or more resources based at least in part on the second group of one or more resources;
train a machine learning model based on the second CSI; and
schedule one or more transmissions for a user equipment using the trained machine learning model.

26. The apparatus of claim 14, wherein the one or more settings indicate one or more sub-groups among the second group of one or more resources via a CSI resource setting, a CSI resource set, or a sub-group identifier.

27. The apparatus of claim 26, wherein each of the one or more sub-groups is associated with a control resource set (CORESET) pool identifier or a transmission-reception point (TRP).

28. A method of wireless communication by a user equipment, comprising:
receiving one or more settings indicating a first group of one or more resources associated with one or more first serving cells in a first cell group, the one or more settings further indicating a second group of one or more resources associated with a second serving cell in a second cell group; and
reporting channel state information (CSI) associated with the second group of one or more resources based at least in part on one or more measurements associated with the first group of one or more resources.

29. The method of claim 28, wherein the second group of one or more resources includes one or more virtual resources, the method further comprising refraining from receiving one or more signals via the one or more virtual resources.

30. A method of wireless communication by a network entity, comprising:
outputting one or more settings indicating a first group of one or more resources associated with one or more first serving cells in a first cell group, the one or more settings further indicating a second group of one or more resources associated with a second serving cell in a second cell group; and
obtaining first channel state information (CSI) associated with the second group of one or more resources based at least in part on the first group of one or more resources.
